(19) United States
(12) Patent Application Publication
(10) Pub. No.: US 2025/0284238 A1
(43) Pub. Date: Sep. 11, 2025

(54) IMAGE FORMING APPARATUS

(71) Applicant: CANON KABUSHIKI KAISHA, Tokyo (JP)

(72) Inventors: JUNYA KOBAYASHI, Shizuoka (JP); SHINYA NODA, Shizuoka (JP); NORIYUKI MONDEN, Boise, ID (US)

(21) Appl. No.: 19/074,214

(22) Filed: Mar. 7, 2025

(30) Foreign Application Priority Data
Mar. 11, 2024 (JP) 2024-037323
Mar. 11, 2024 (JP) 2024-037324
Mar. 11, 2024 (JP) 2024-037325

(51) Int. Cl. G03G 15/00; G03G 15/01; G03G 15/16; G03G 15/20; G03G 21/16

(52) U.S. Cl. CPC G03G 15/80; G03G 15/0189; G03G 15/167; G03G 15/2017; G03G 15/6511; G03G 15/6552; G03G 15/757; G03G 21/1638; G03G 21/1652

(57) ABSTRACT

An image forming apparatus includes (i) an apparatus body including first and second end portions located opposite each other in a first direction, the first end portion having an opening, the apparatus body including a first side wall at one end in a second direction that is orthogonal to a vertical direction and to the first direction; (ii) a drawable unit movable in a direction intersecting the second direction and movable between an inside position and an outside position through the opening; (iii) a fixing device located closer to the first end portion than to the second end portion in the first direction; (iv) a power source board configured to supply electrical power to the fixing device; and (v) an inlet electrically connected to the power source board and located closer to the second end portion than to the first end portion in the first direction.

### BACKGROUND

### Field

The present disclosure relates to an image forming apparatus configured to form an image on a recording material.

### Description of the Related Art

Image forming apparatuses such as printers, copiers, and multifunction machines include an apparatus in which a cartridge is detachably attached to a tray that is movable between the inside and the outside of the body of the apparatus.

An image forming apparatus disclosed in Japanese Patent Laid-Open No. 2010-244018 includes a tray to which cartridges are detachably attached, and a fixing device. The tray is movable to the outside of the body of the image forming apparatus through a plurality of openings.

Another image forming apparatus disclosed in Japanese Patent Laid-Open No. 2015-206897 includes a tray to which cartridges are detachably attached, a transfer unit, and a fixing device. According to Japanese Patent Laid-Open No. 2015-206897, the tray and the transfer unit are movable from the inside of the image forming apparatus to the outside of the image forming apparatus. Specifically, the fixing device is located on a one-end side of the body of the image forming apparatus. When the transfer unit moves to the outside of the apparatus body, the transfer unit travels in a direction from an other-end side of the apparatus body toward the one-end side. When the tray moves to the outside of the apparatus body, the tray travels in a direction from the one-end side of the apparatus body toward the other-end side.

Yet another image forming apparatus disclosed in Japanese Patent Laid-Open No. 2016-20932 includes a tray to which cartridges are detachably attached, and a power source.

### SUMMARY

The present disclosure further develops the known arts. Specifically, the present disclosure provides an image forming apparatus in which electric components are arranged in a reduced space.

Various features of the disclosure according to the present application are characterized as follows.

According to a first aspect of the present disclosure, an image forming apparatus is configured to form an image on a recording material. The image forming apparatus includes an apparatus body including a first end portion and a second end portion with respect to a first direction that is orthogonal to a vertical direction, the first end portion having an opening, the second end portion being located opposite the first end portion, the apparatus body including a first side wall located at one end of the apparatus body in a second direction that is orthogonal to the vertical direction and to the first direction; a drawable unit movable relative to the first side wall in a direction intersecting the second direction, the drawable unit being movable between an inside position that is inside the apparatus body and an outside position that is outside the apparatus body through the opening; a fixing device configured to heat the recording material and located closer to the first end portion than to the second end portion in the first direction; a power source board configured to supply electrical power to the fixing device; and an inlet electrically connected to the power source board and located closer to the second end portion than to the first end portion in the first direction. In the first direction, at least part of the power source board is located closer to the second end portion than the fixing device is to the second end portion, and closer to the first end portion than the inlet is to the first end portion.

According to a second aspect of the present disclosure, an image forming apparatus is configured to form an image on a recording material. The image forming apparatus includes an apparatus body including a first end portion and a second end portion with respect to a first direction that is orthogonal to a vertical direction, the first end portion having an opening, the second end portion being located opposite the first end portion, the apparatus body including a first side wall; a second side wall; a rear wall; and an upper wall, the first side wall being located at one end of the apparatus body in a second direction that is orthogonal to the vertical direction and to the first direction, the second side wall being located at the other end of the apparatus body in the second direction, the rear wall being located at the second end portion, at least part of the rear wall being located between the first side wall and the second side wall in the second direction, at least part of the upper wall being located between the first side wall and the second side wall in the second direction; a drawable unit movable relative to the first side wall in a direction intersecting the second direction, the drawable unit being movable between an inside position that is inside the apparatus body and an outside position that is outside the apparatus body through the opening, at least part of the drawable unit that is in the inside position being located below the upper wall; a fixing device configured to heat the recording material and located closer to the first end portion than to the second end portion in the first direction; a power source board provided on the first side wall; and a first electric board provided on the rear wall or the upper wall.

According to a third aspect of the present disclosure, an image forming apparatus is configured to form an image on a recording material. The image forming apparatus includes an apparatus body including a first end portion and a second end portion with respect to a first direction that is orthogonal to a vertical direction, the second end portion being located opposite the first end portion, the apparatus body including a first side wall located at one end of the apparatus body in a second direction that is orthogonal to the vertical direction and to the first direction; an image forming unit configured to transfer an image to a recording material at a transfer portion, the image forming unit including a drawable unit movable between an inside position that is inside the apparatus body and an outside position that is outside the apparatus body, the drawable unit including a plurality of rotary bodies including a first rotary body and a second rotary body, the transfer portion being located closer to the first end portion than to the second end portion in the first direction; a drive unit including a drive source and a drive train, the drive train being configured to transmit a driving force of the drive source to each of the first rotary body and the second rotary body, the drive unit being provided on the first side wall; a fixing device configured to heat the recording material and located closer to the first end portion than to the second end portion in the first direction; and a power source unit provided on the first side wall, the power source unit including a power source board and a casing that houses the power source board. When the drawable unit is in the inside position, the first rotary body is located closer to the first end portion than the second rotary body is to the first end portion in the first direction, and at least part of the first rotary body is located higher than the second rotary body in the vertical direction. The power source unit is located above the drive unit in the vertical direction. As viewed in the vertical direction, the power source unit and the drive unit at least partially overlap each other.

According to a fourth aspect of the present disclosure, an image forming apparatus is configured to form an image on a recording material. The image forming apparatus includes an apparatus body including a first end portion and a second end portion with respect to a first direction that is orthogonal to a vertical direction, the first end portion having an opening, the second end portion being located opposite the first end portion, the apparatus body including a first side wall located at one end of the apparatus body in a second direction that is orthogonal to the vertical direction and to the first direction; a drawable unit movable relative to the first side wall in a direction intersecting the second direction, the drawable unit including a rotary body, the drawable unit being movable between an inside position that is inside the apparatus body and an outside position that is outside the apparatus body through the opening; a drive unit including a drive source and a drive train, the drive train being configured to transmit a driving force of the drive source to the rotary body, the drive unit being provided on the first side wall; a fixing device configured to heat the recording material and located closer to the first end portion than to the second end portion in the first direction; and a power source unit provided on the first side wall, the power source unit including a power source board and a casing that houses the power source board. Defining a direction of travel of the drawable unit moving from the inside position to the outside position as a drawing direction, the drawable unit that is in the inside position is inclined such that a downstream portion of the drawable unit in the drawing direction is located higher than an upstream portion of the drawable unit. The power source unit is located above the drive unit in the vertical direction. As viewed in the vertical direction, the power source unit and the drive unit at least partially overlap each other.

Further features of the present disclosure will become apparent from the following description of exemplary embodiments with reference to the attached drawings.

### BRIEF DESCRIPTION OF THE DRAWINGS

FIG. 1 illustrates an overall configuration of a printer according to Example 1.

FIG. 2 illustrates the printer according to Example 1 with a door thereof open.

FIG. 3 illustrates the printer according to Example 1 with a fixing device thereof moved.

FIG. 4 illustrates the printer according to Example 1 with a transfer unit and a tray unit thereof drawn out.

FIG. 5 illustrates the printer according to Example 1 with the transfer unit solely drawn out.

FIG. 6 illustrates how the transfer unit and the tray unit move in Example 1.

FIG. 7 illustrates how the transfer unit and the tray unit move in Example 1.

FIG. 8 illustrates a coupling member that couples a tray of the tray unit and the transfer unit to each other in Example 1.

FIG. 9 illustrates the coupling member that couples the tray of the tray unit and the transfer unit to each other in Example 1.

FIG. 10 illustrates the coupling member that couples the tray of the tray unit and the transfer unit to each other in Example 1.

FIG. 11 illustrates the positions of electric components included in the printer according to Example 1.

FIG. 12 illustrates the positions of electric components included in the printer according to Example 1.

FIG. 13 illustrates the positions of the door and an inlet in Example 1.

FIG. 14 illustrates the position of a power source unit in Example 1.

FIG. 15 illustrates the position of the power source unit in Example 1.

FIG. 16 illustrates the positions of electric components included in a printer according to Example 2.

FIG. 17 illustrates the positions of electric components included in a printer according to Example 3.

FIG. 18 illustrates the positions of electric components included in a printer according to Example 4.

FIG. 19 illustrates the positions of electric components included in a printer according to Example 5.

FIG. 20 illustrates the positions of electric components included in a printer according to Example 6.

FIG. 21 illustrates a control board according to Example 6.

FIG. 22 illustrates the positions of electric components included in a printer according to Example 7.

FIGS. 23A and 23B illustrate how power is supplied to the tray unit.

### DESCRIPTION OF THE EMBODIMENTS

Various exemplary embodiments, features, and aspects of the present disclosure will now be described in detail with specific examples and with reference to the drawings. The dimensions, materials, shapes, and relative positions of elements with respect to the following description of the embodiments are to be changed as appropriate with the configuration and relevant conditions of an apparatus to which the present disclosure is applied. That is, the scope of the present disclosure is not limited to the following embodiment.

### Example 1

### Overall Configuration

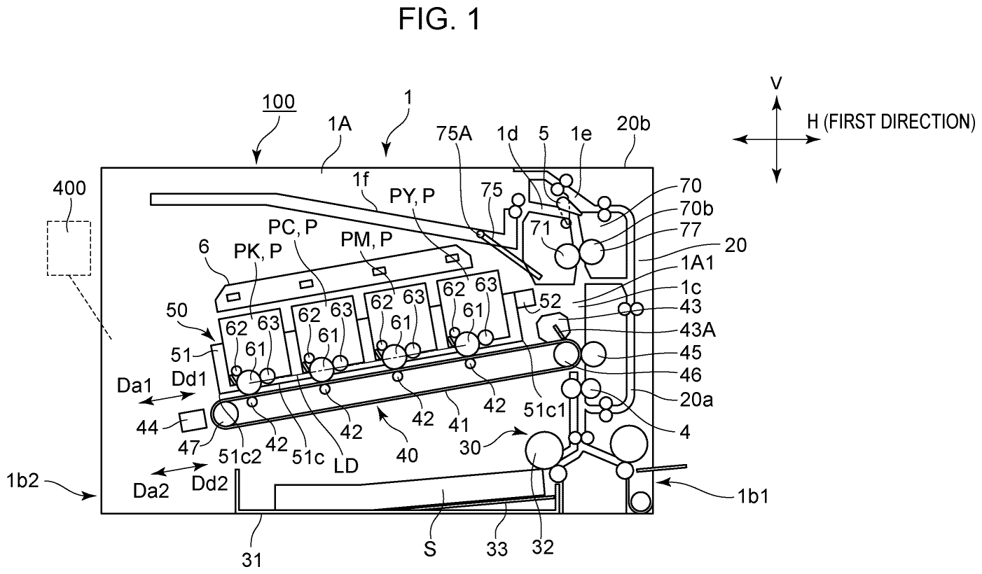

Referring to FIG. 1, a printer 1 provided as an image forming apparatus will now be described. FIG. 1 illustrates an overall configuration of the printer 1 according to Example 1. In the present embodiment, the printer 1 is an electrophotographic color laser-beam printer configured to form an image on a sheet S, which corresponds to a recording material.

The printer 1 includes an apparatus body (housing) 1A, a scanner (exposure device) 6, and a door (opening-and-closing member) 20. The door 20 is openable and closable on the apparatus body 1A. The printer 1 further includes a sheet feeder 30, a transfer unit (transfer device) 40, a tray unit (moving unit, supporting unit, or drawable unit) 50, and a fixing device 70. A combination of the apparatus body 1A and the door 20 is also referred to as a main frame 100. The main frame 100 includes exterior members of the printer 1.

The apparatus body 1A houses the scanner 6, the sheet feeder 30, the transfer unit 40, the tray unit 50, and the fixing device 70.

The sheet feeder 30 includes a stacking tray (stacking cassette, or stacker) 31 and a feed roller (feeding roller) 32. Sheets S as recording materials are stacked on the stacking tray 31 and are each conveyed from the stacking tray 31 by the feed roller 32. The stacking tray 31 is drawable or movable toward the side of the door 20, so that sheets S can be refilled. The stacking tray 31 includes an inner plate 33, which is configured to lift the sheets S in such a manner as to bring the sheets S into contact with the feed roller 32.

The tray unit 50 includes a tray (supporting member or drawer) 51 and cartridges PY, PM, PC, and PK. The tray 51 includes a tray handle 52. The cartridges PY, PM, PC, and PK are detachably attached to the tray 51.

The cartridges PY, PM, PC, and PK are individually attachable to and detachable from the tray 51. The cartridges PY, PM, PC, and PK contain respective toners (developers) having respective colors of yellow (Y), magenta (M), cyan (C), and black (K). The cartridges PY, PM, PC, and PK have the same configuration except that the colors of the toners contained therein are different. Therefore, one of the cartridges PY, PM, PC, and PK may be taken in describing the configuration and operation thereof, and description of the others may occasionally be omitted. If the cartridges PY, PM, PC, and PK do not need to be distinguished from one another, the cartridges PY, PM, PC, and PK may each simply be referred to as a cartridge P. That is, it can also be expressed that the tray unit 50 includes a plurality of cartridges P and a tray 51, to which the plurality of cartridges P are detachably attached.

In Example 1, the tray unit 50 includes a plurality of photoconductor drums (image carrying members) 61, a plurality of charging rollers (charging members) 62, and a plurality of developing rollers (developer carrying members) 63. Specifically, the tray unit 50 includes four photoconductor drums 61, four charging rollers 62, and four developing rollers 63. The direction of the rotation axes of the photoconductor drums 61, the direction of the rotation axes of the developing rollers 63, and the direction of the rotation axes of the charging rollers 62 are parallel to each other.

A unit configured to form a black (K) image is referred to as a black station (first station). The photoconductor drum 61, the developing roller 63, and the charging roller 62 of the first station are referred to as a first photoconductor drum, a first developing roller, and a first charging roller, respectively.

A unit configured to form a cyan (C) image is referred to as a cyan station (second station). The photoconductor drum 61, the developing roller 63, and the charging roller 62 of the second station are referred to as a second photoconductor drum, a second developing roller, and a second charging roller, respectively.

A unit configured to form a magenta (M) image is referred to as a magenta station (third station). The photoconductor drum 61, the developing roller 63, and the charging roller 62 of the third station are referred to as a third photoconductor drum, a third developing roller, and a third charging roller, respectively.

A unit configured to form a yellow (Y) image is referred to as a yellow station (fourth station). The photoconductor drum 61, the developing roller 63, and the charging roller 62 of the fourth station are referred to as a fourth photoconductor drum, a fourth developing roller, and a fourth charging roller, respectively.

The cartridge PK is attached to the black station. The cartridge PC is attached to the cyan station. The cartridge PM is attached to the magenta station. The cartridge PY is attached to the yellow station. In the present embodiment, the cartridge PK is referred to as a first cartridge, the cartridge PC is referred to as a second cartridge, the cartridge PM is referred to as a third cartridge, and the cartridge PY is referred to as a fourth cartridge.

In the present embodiment, the first photoconductor drum, the second photoconductor drum, the third photoconductor drum, and the fourth photoconductor drum may be regarded as an exemplary first rotary body, an exemplary second rotary body, an exemplary third rotary body, and an exemplary fourth rotary body, respectively. The first developing roller, the second developing roller, the third developing roller, and the fourth developing roller may also be regarded as an exemplary first rotary body, an exemplary second rotary body, an exemplary third rotary body, and an exemplary fourth rotary body, respectively. Accordingly, it can also be stated that the tray unit 50 includes a plurality of rotary bodies, and the plurality of rotary bodies include first to fourth rotary bodies.

The numbers of orders, that is, first; second; third; and fourth, are defined only for convenience of distinguishing elements and may be interchanged as appropriate.

The photoconductor drum 61, the charging roller 62, and the developing roller 63 may be included in at least one of each cartridge P and the tray 51. In Example 1, the cartridge P includes the photoconductor drum 61, the charging roller 62, and the developing roller 63.

The transfer unit 40 includes a belt (intermediate transfer belt) 41, a driving roller 46, primary transfer rollers 42, a cleaner 43, and a tension roller (driven roller) 47. The driving roller 46 is to move the belt 41. The printer 1 according to Example 1 includes an optical sensor 44, which is configured to detect any toner image transferred to the belt 41. In Example 1, the belt 41 is located below the photoconductor drums 61 and is allowed to come into contact with the photoconductor drums 61 such that primary transfer portions are formed between the belt 41 and the individual photoconductor drums 61. The printer 1 further includes a secondary transfer roller 45, which is in contact with the belt 41 such that a secondary transfer portion is formed. The secondary transfer portion is formed between the belt 41 and the secondary transfer roller 45. The direction of the rotation axes of the primary transfer rollers 42, the direction of the rotation axis of the driving roller 46, the direction of the rotation axis of the tension roller 47, and the direction of the rotation axis of the secondary transfer roller 45 are parallel to each other. At a position before the secondary transfer portion, a registration roller pair 4 is provided.

The fixing device 70 includes a fixing unit 70b and a flapper 5. In an image forming operation that is performed on a sheet S, the fixing device 70 is in an in-use position. When in the in-use position, the fixing device 70 is housed in (located inside) the apparatus body 1A. The fixing device 70 is configured to heat the sheet S when in the in-use position. In the present embodiment, the fixing unit 70b includes a heating part (heating roller) 71 and a pressing part (pressure roller) 77. The heating part 71 includes a heater.

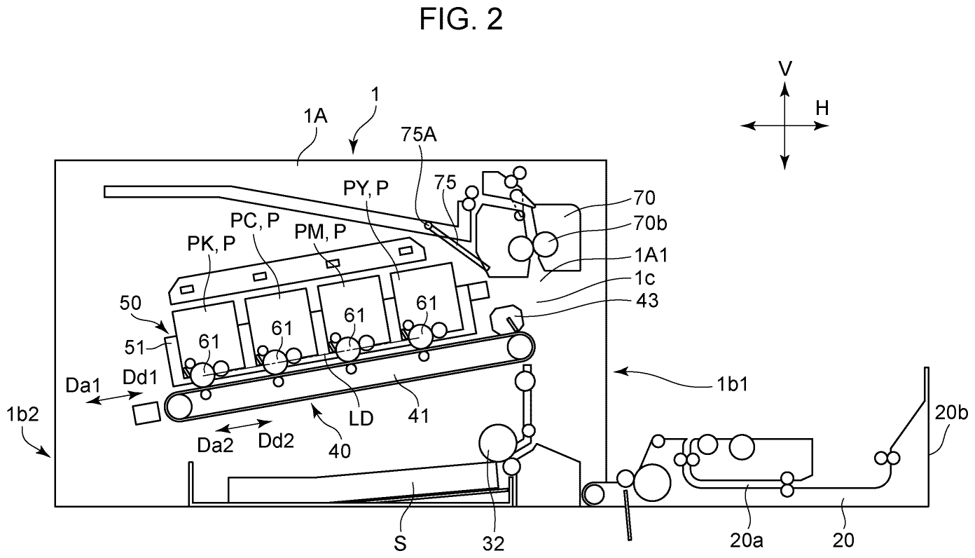

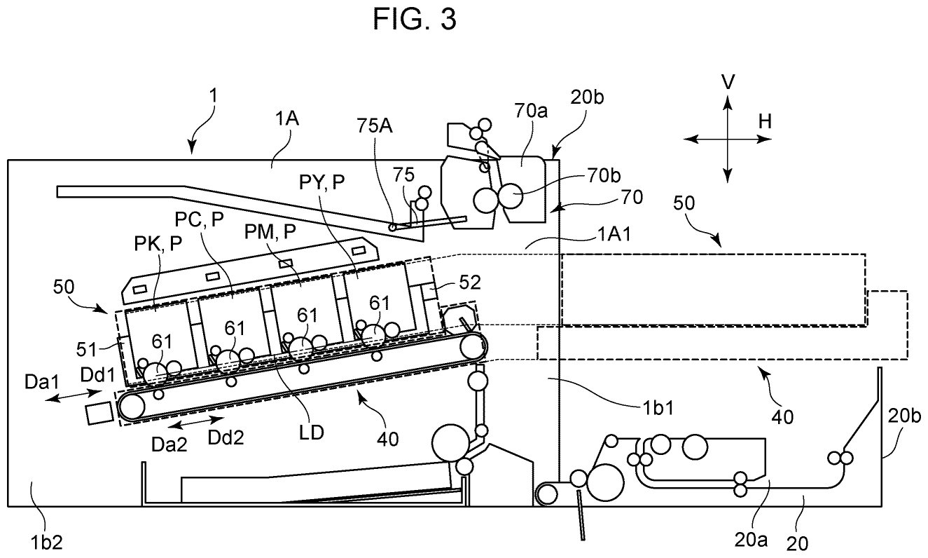

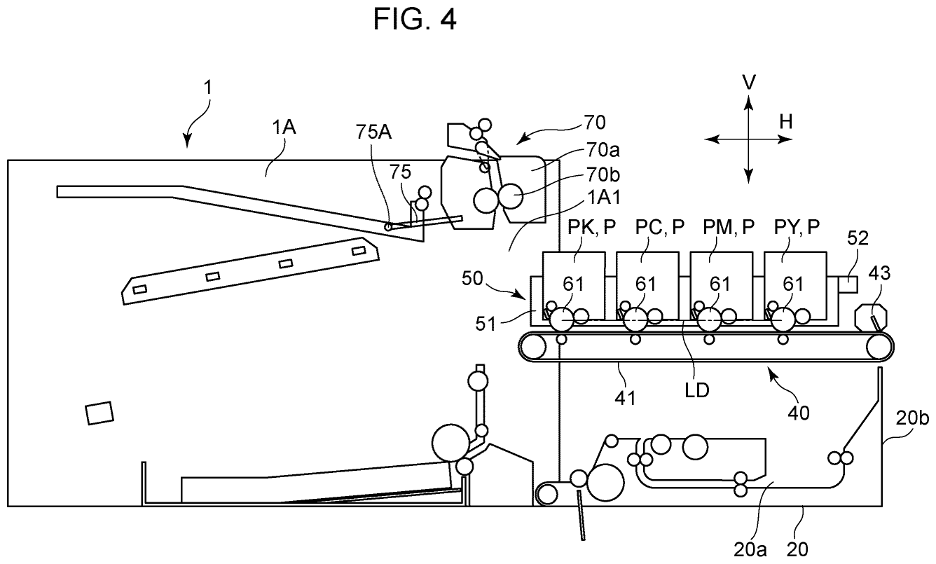

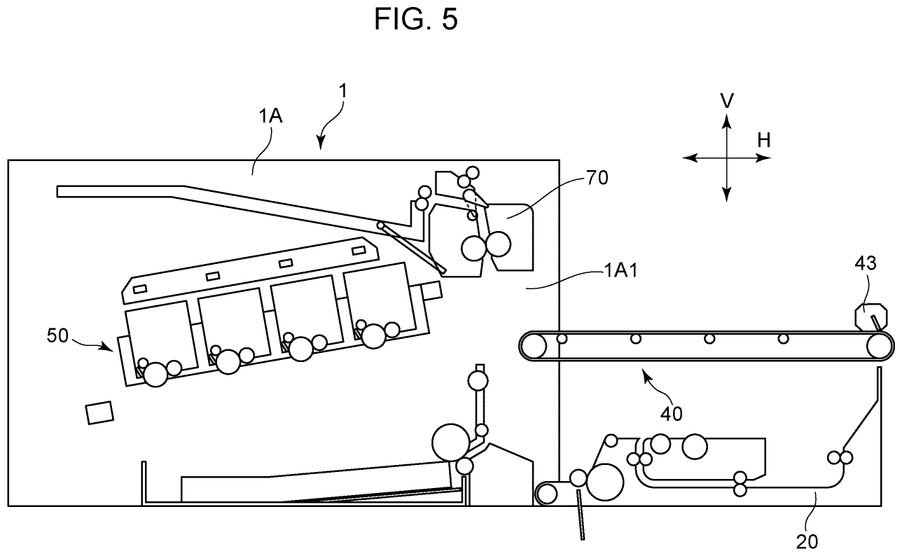

Referring to FIGS. 1 to 5, how the transfer unit 40 and the tray unit 50 move will now be described. FIG. 2 illustrates the printer 1 with the door 20 open. FIG. 3 illustrates the printer 1 with the fixing device 70 moved. FIG. 4 illustrates the printer 1 with the transfer unit 40 and the tray unit 50 drawn out. FIG. 5 illustrates the printer 1 with the transfer unit 40 solely drawn out.

The transfer unit 40 and the tray unit 50 are movable from the inside of the apparatus body 1A to the outside of the apparatus body 1A. The apparatus body 1A has a first end portion 1b1 and a second end portion 1b2, which are with respect to a horizontal direction H. The first end portion 1b1 has an opening 1A1. The second end portion 1b2 is located opposite the first end portion 1b1. The tray unit 50 is movable through the opening 1A1 between a first inside position that is inside the apparatus body 1A and a first outside position that is outside the apparatus body 1A. The transfer unit 40 is movable through the opening 1A1 between a second inside position that is inside the apparatus body 1A and a second outside position that is outside the apparatus body 1A. The opening 1A1 may include an opening provided for the tray unit 50 to pass through and an opening provided for the transfer unit 40 to pass through. Along with the transfer unit 40 moving from the second inside position to the second outside position, at least the belt 41 is moved such that at least part of the belt 41 projects from the apparatus body 1A to the outside of the apparatus body 1A.

A direction in which the tray unit 50 moves from the first inside position to the first outside position is referred to as a tray detaching direction (first detaching direction) Dd1. A direction opposite to the tray detaching direction Dd1 is referred to as a tray attaching direction (first attaching direction) Da1. The tray detaching direction Dd1 can also be expressed as a direction heading from the second end portion 1b2 toward the first end portion 1b1.

A direction in which the transfer unit 40 moves from the second inside position to the second outside position is referred to as a transfer detaching direction (second detaching direction) Dd2. A direction opposite to the transfer detaching direction Dd2 is referred to as a transfer attaching direction (second attaching direction) Da2. In the transfer detaching direction Dd2, the driving roller 46 is located on the downstream side relative to the tension roller 47. The transfer detaching direction Dd2 can also be expressed as a direction heading from the second end portion 1b2 toward the first end portion 1b1.

The tray detaching direction Dd1 and the tray attaching direction Da1 are each a direction intersecting (preferably orthogonal to) the direction of the rotation axes of the photoconductor drums 61. The transfer detaching direction Dd2 and the transfer attaching direction Da2 are each a direction intersecting (preferably orthogonal to) the direction of the rotation axis of the driving roller 46. The direction of the rotation axis of the driving roller 46 is parallel to the direction of the rotation axes of the photoconductor drums 61.

In the horizontal direction H, the fixing device 70 is located on a one-end or first side (the side on which the first end portion 1b1 is located) of the apparatus body 1A.

The door 20 attached to the apparatus body 1A is movable between a closed position and an open position. When the door 20 is in the closed position (in a closed state of the door 20) as illustrated in FIG. 1, the door 20 covers the opening 1A1. When the door 20 is in the open position (in an open state of the door 20) as illustrated in FIG. 2, the opening 1A1 is exposed.

When the door 20 is in the closed position as illustrated in FIG. 1, the door 20 covers the fixing device 70 attached to the apparatus body 1A. More specifically, when the door 20 is in the closed position, an upper cover portion 20b included in the door 20 is located above the fixing device 70. The upper cover portion 20b of the door 20 has a function as one of the exterior members.

The door 20 is movable between the open position and the closed position with the fixing device 70 supported by the apparatus body 1A. More specifically, the door 20 moves from the closed position to the open position in such a manner as to move away from the fixing device 70 supported by the apparatus body 1A. In other words, the door 20 that is in the open position as illustrated in FIG. 2 is located away from the fixing device 70 supported by the apparatus body 1A.

As will be described below, the fixing device 70 is movable from the position illustrated in FIG. 2 to the position illustrated in FIG. 3 such that the opening 1A1 is widely exposed. With the door 20 and the fixing device 70 moved (as illustrated in FIG. 3), the transfer unit 40 and the tray unit 50 are allowed to move from the inside of the apparatus body 1A to the outside of the apparatus body 1A through the opening 1A1. The transfer unit 40 and the tray unit 50 thus moved are positioned as illustrated in FIG. 4.

With the tray unit 50 moved to the outside of the apparatus body 1A (as illustrated in FIG. 4), the cartridges PY, PM, PC, and PK are allowed to be detached from the tray 51 and to be attached to the tray 51. Therefore, the user is allowed to replace the cartridges PY, PM, PC, and PK with fresh cartridges PY, PM, PC, and PK. In Example 1, the cartridges P are attachable to and detachable from the tray 51 in a direction intersecting (preferably orthogonal to) the rotation axes of the photoconductor drums 61.

The cartridges PY, PM, PC, and PK are to be detached from the tray 51 by being moved relative to the tray 51 in a direction away from the transfer unit 40. In other words, to detach the cartridges PY, PM, PC, and PK from the tray 51, the cartridges PY, PM, PC, and PK are moved relative to the tray 51 toward a side opposite the transfer unit 40. In the present embodiment, the transfer unit 40 is located below the tray unit 50. Therefore, the cartridges PY, PM, PC, and PK to be detached from the tray 51 are moved upward relative to the tray 51.

The transfer unit 40 is detachable from the apparatus body 1A independently of the tray unit 50 and is replaceable with a fresh transfer unit 40.

### Image Forming Operation

Referring to FIG. 1, the image forming operation that is performed by the printer 1 will now be described. The printer 1 is connected to an external host device (external instrument, or external device) 400. In a case where the printer 1 receives an image signal from the external host device 400, the printer 1 is configured to start an image forming operation that is performed on a sheet S based on the received image signal. Examples of the external host device 400 include a personal computer, an image reader, and a facsimile.

In the image forming operation that is performed on a sheet S, the fixing device 70 is in the in-use position, the tray unit 50 is in the first inside position, the transfer unit 40 is in the second inside position, and the door 20 is in the closed position. With the transfer unit 40 being in the second inside position, the belt 41 is allowed to make contact with the photoconductor drums 61. In such a state, the tray unit 50 is located above the transfer unit 40.

A charging voltage is applied to the charging rollers 62, and the photoconductor drums 61 are rotated. The scanner 6 applies laser beams generated in correspondence with image information respectively to the photoconductor drums 61, whereby the surfaces of the photoconductor drums 61 that are precharged by the respective charging rollers 62 are exposed to the laser beams. Thus, electrostatic latent images corresponding to the image information are formed on the surfaces of the respective photoconductor drums 61.

The developing rollers 63 carry the respective toners. A developing voltage is applied to the developing rollers 63, whereby the electrostatic latent images formed on the photoconductor drums 61 are developed with the toners supplied from the developing rollers 63. Thus, respective toner images are formed on the surfaces of the photoconductor drums 61. In Example 1, the development of the electrostatic latent images is performed with the developing rollers 63 being in contact with the photoconductor drums 61. Alternatively, the development of the electrostatic latent images by using the developing rollers 63 may be performed with gaps produced between the developing rollers 63 and the photoconductor drums 61.

If a full-color image is to be formed, toner images in the respective colors are formed on the respective photoconductor drums 61.

In Example 1, with the tray unit 50 being in the first inside position, the developing rollers 63 are movable between a contact position where the developing rollers 63 are in contact with the photoconductor drums 61 and an away position where the developing rollers 63 are away from or not in contact with the photoconductor drums 61. Specifically, the state of the developing rollers 63 is changed by a changing device provided in the apparatus body 1A between a state where the developing rollers 63 are in the contact position and a state where the developing rollers 63 are in the away position or a non-contact position. Hence, when no image forming operation is to be performed, the developing rollers 63 are kept away from or not in contact with the photoconductor drums 61.

The printer 1 is capable of performing monochrome printing with the developing roller 63 for the cartridge PK being in contact with the corresponding photoconductor drum 61 but with the developing rollers 63 for the cartridges PY, PM and PC being away from the corresponding photoconductor drums 61. The printer 1 is capable of performing a full-color printing with the photoconductor drums 61 for the cartridges PY, PM, PC, and PK being in contact with the belt 41.

The toner images formed on the respective photoconductor drums 61 are transferred to the belt 41 at the respective primary transfer portions by the respective primary transfer rollers 42, and the toner images are conveyed to the secondary transfer portion formed between the belt 41 and the secondary transfer roller 45.

On the other hand, a conveyance path (first path or first conveyance path) 1c runs inside the apparatus body 1A. The sheet S heading toward the fixing device 70 is conveyed along the conveyance path 1c. Furthermore, a duplex conveyance path (second path or second conveyance path) 20a runs inside the door 20. The sheet S exited from the fixing device 70 is conveyed along the conveyance path 20a. The door 20 when closed covers the conveyance path 1c. When the door 20 is open, the conveyance path 1c and the duplex conveyance path 20a are exposed (see FIG. 2).

In the sheet feeder 30, the feed roller 32 separates one sheet S from the stack of sheets S in the stacking tray 31 at a predetermined timing. Any skew in the one sheet S is corrected by the registration roller pair 4. The sheet S is then conveyed along the conveyance path 1c to the secondary transfer portion and further to the fixing device 70.

At the secondary transfer portion, the toner image is transferred from the belt 41 to the sheet S. Toner particles not transferred to the sheet S are removed from the belt 41 by a cleaning blade (cleaning member) 43A, which is included in the cleaner 43.

It can also be stated that the printer 1 includes an image forming unit (image forming section) configured to form an image on a sheet S at a transfer portion (secondary transfer portion). In the present embodiment, the image forming unit includes the tray unit 50 and the transfer unit 40. In the horizontal direction H, the secondary transfer portion is located closer to the first end portion 1b1 than to the second end portion 1b2.

The sheet S having the toner image transferred thereto at the secondary transfer portion is conveyed toward the fixing device 70. In the fixing device 70, the sheet S is heated and pressed by the fixing unit 70b, whereby the toner image is fixed to the sheet S. The sheet S having the fixed toner image is conveyed to the flapper 5, which serves as a path changer.

The flapper 5 is movable between a sheet discharge position and a sheet reversal position. In the sheet discharge position, the flapper 5 guides the sheet S, exited from the fixing device 70, toward a sheet discharge path 1d. In the sheet reversal position, the flapper 5 guides the sheet S to a sheet reversal path 1e.

In simplex printing in which an image is formed on the front side of the sheet S, the flapper 5 guides the sheet S to the sheet discharge path 1d so that the sheet S is discharged to a discharge tray 1f, which is provided at an upper part of the apparatus body 1A.

In duplex printing in which an image is formed on both of the front and back sides of the sheet S, the flapper 5 guides the sheet S to the sheet reversal path 1e. After the sheet S is guided to the sheet reversal path 1e, the direction of conveyance of the sheet S is reversed. Accordingly, the sheet S advances along the duplex conveyance path 20a running inside the door 20 and is conveyed toward the secondary transfer portion. At the secondary transfer portion, a toner image is transferred to the back side of the sheet S. Then, the sheet S advances through the fixing device 70, is guided by the flapper 5 to the sheet discharge path 1d, and is discharged to the discharge tray 1f provided on the apparatus body 1A.

### How to Detach Tray Unit and Transfer Unit, and Location of Fixing Device

Referring to FIGS. 1 to 5, how to detach the tray unit 50 and the transfer unit 40 from the apparatus body 1A and the location of the fixing device 70 will now be described.

As described above, the fixing device 70 of the printer 1 is located on the one-end or first side of the apparatus body 1A in the horizontal direction H. Furthermore, the transfer unit 40 and the tray unit 50 are movable to the outside of the apparatus body 1A through the opening 1A1 provided on the one-end or first side of the apparatus body 1A.

In other words, the fixing device 70 is located closer in the horizontal direction H to the first end portion 1b1 than to the second end portion 1b2. That is, in the horizontal direction H, the distance between the fixing device 70 and the first end portion 1b1 is shorter than the distance between the fixing device 70 and the second end portion 1b2. It can also be stated that the fixing device 70 is located closer to the first end portion 1b1 than to the center of the apparatus body 1A in the horizontal direction H, and that, in the horizontal direction H, the distance between the first end portion 1b1 and the fixing device 70 is shorter than the distance between the first end portion 1b1 and the center of the apparatus body 1A.

As described above, the direction of travel of the tray unit 50 moving from the first inside position to the first outside position intersects the rotation axes of the photoconductor drums 61. In such a movement, the tray unit 50 travels away from the second end portion 1b2.

As described above, the direction of travel of the transfer unit 40 moving from the second inside position to the second outside position intersects the rotation axis of the driving roller 46. In such a movement, the transfer unit 40 travels away from the second end portion 1b2.

As described above, the door 20 according to Example 1 when closed covers the opening 1A1 and also covers at least part of the conveyance path 1c provided for the sheet S. The door 20 has the duplex conveyance path 20a.

If a sheet S is jammed, the user of the printer 1 is allowed to eliminate the jam by removing the sheet S from the one-end or first side of the apparatus body 1A. Specifically, the user moves the door 20 to the open position and accesses the inside of the apparatus body 1A. Thus, the user is allowed to remove the jammed sheet S. If a portion of the sheet S exited from the fixing device 70 is exposed to the outside of the apparatus body 1A, the user may remove the sheet S by pulling the sheet S from the outside of the apparatus body 1A without opening the door 20.

The user of the printer 1 is also allowed to check the states of the transfer unit 40 and the cartridges P and to perform maintenance work, replacement work, and the like by moving the transfer unit 40 and the tray unit 50 to the outside of the apparatus body 1A on the one-end or first side of the apparatus body 1A.

That is, in the printer 1, while the fixing device 70 is located on the one-end or first side of the apparatus body 1A, the transfer unit 40 and the tray unit 50 are movable between the inside and the outside of the apparatus body 1A on the one-end or first side of the apparatus body 1A. Hence, the elimination of the jam, the access to the fixing device 70, and the operation of the transfer unit 40 and the tray unit 50 that are to be performed by the user are all performable on the first side.

In the present embodiment, the side of the printer 1 on which the door 20 is provided is defined as the front side. Therefore, it is sufficient that a space for performing relevant work, such as the elimination of the jam and the operation of the transfer unit 40 and the tray unit 50, is provided on the front side of the printer 1. That is, a space for performing such work does not need to be provided on the left side, the right side, the rear side, and the upper side of the printer 1. Hence, the space to be secured for installing the printer 1 is reduced.

If the transfer unit 40 or the tray unit 50 is configured to be drawn out of or moved from the apparatus body 1A on the other-end or second side, the user who attempts to eliminate the jam or to draw out the transfer unit 40 or the tray unit 50 needs to access both of the first and second sides of the apparatus body 1A. Furthermore, if one of the transfer unit 40 and the tray unit 50 is configured to be drawn out of or moved from the apparatus body 1A on the one-end or first side while the other of the transfer unit 40 and the tray unit 50 is configured to be drawn out of the apparatus body 1A on the other-end or second side, the user needs to access both of the first and second sides of the apparatus body 1A. In such a configuration, a space for performing the above work needs to be provided not only on the front side of the apparatus body 1A but also on the rear side of the apparatus body 1A, leading to an increase in the area to be secured for installing the printer 1.

In Example 1, the refilling of sheets S is performable on the one-end or first side of the apparatus body 1A. Therefore, it is sufficient that a space for refilling sheets S is provided on the front side of the printer 1. Hence, the space to be secured for installing the printer 1 is reduced.

### Relationship Between Tray Unit and Fixing Device

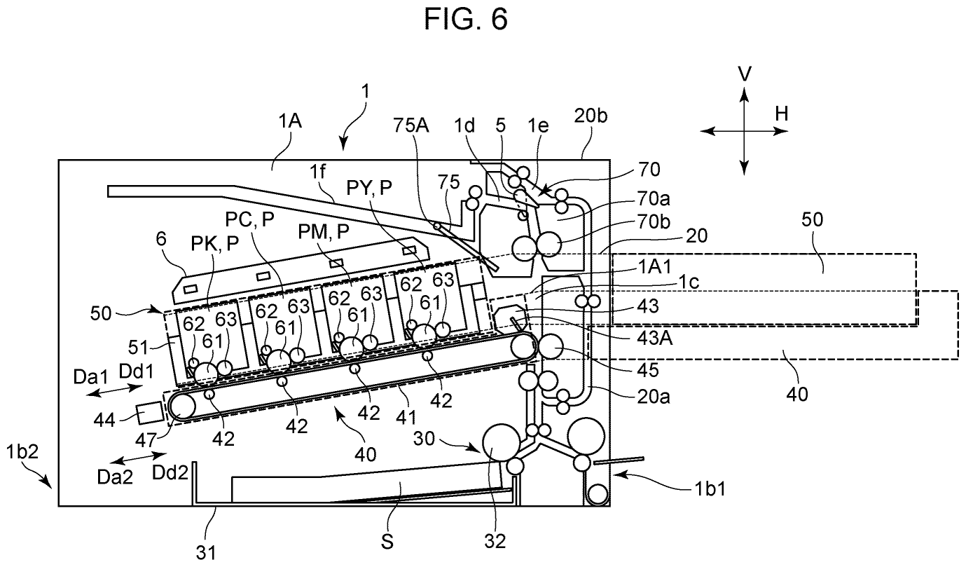

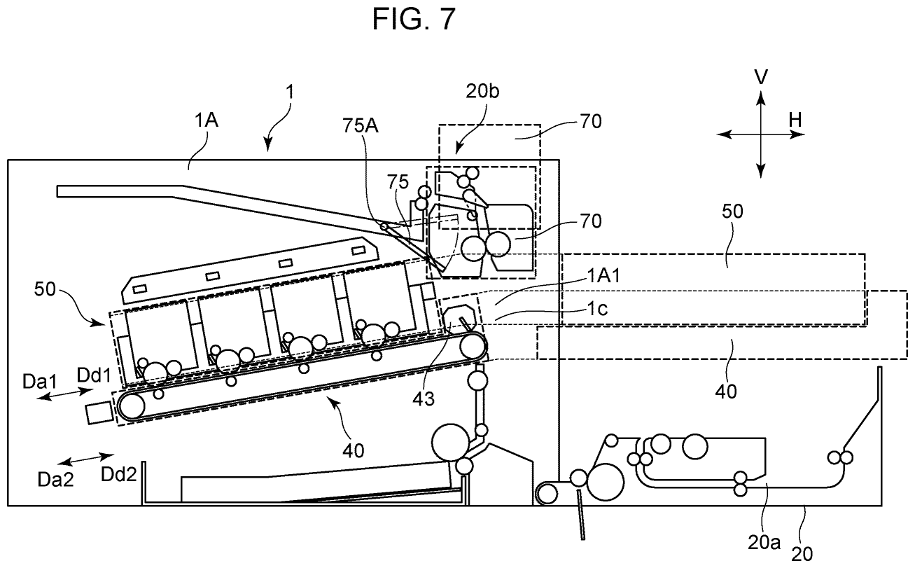

Referring to FIGS. 1 to 4, 6, and 7, the relationship between the tray unit 50 and the fixing device 70 will now be described. FIGS. 6 and 7 illustrate how the transfer unit 40 and the tray unit 50 move.

When the tray unit 50 moves between the first inside position where an image forming operation is performed on a sheet S and the first outside position where the cartridges P are allowed to be replaced, the tray unit 50 travels through a predetermined space.

The space through which the tray unit 50 travels when moving from the first inside position to the first outside position is referred to as a first space (a traveling space for the tray unit 50). The first space may also be referred to as a path or locus (first traveling path or first traveling locus) along which the tray unit 50 travels when moving from the first inside position to the first outside position.

When the transfer unit 40 moves between the second inside position where an image forming operation is performed on a sheet S and the second outside position, the transfer unit 40 travels through a predetermined space. The space through which the transfer unit 40 travels when moving from the second inside position to the second outside position is referred to as a second space (a traveling space for the transfer unit 40). The second space may also be referred to as a path or locus (second traveling path or second traveling locus) along which the transfer unit 40 travels when moving from the second inside position to the second outside position.

The position (in-use position) of the fixing device 70 that is taken when an image forming operation is to be performed on a sheet S has the following relationship with the first space and the second space.

As illustrated in FIGS. 6 and 7, at least part of the fixing device 70 that is in the in-use position overlaps the first space. In other words, when the fixing device 70 is in the in-use position, at least part of the fixing device 70 is located inside the first space.

In Example 1, at least part of the fixing device 70 overlaps the space through which the cartridges P are to travel along with the tray unit 50 moving from the first inside position to the first outside position. Alternatively, at least part of the fixing device 70 may overlap a space through which the tray 51 travels.

In such an arrangement, the apparatus body 1A can have a smaller size than in an arrangement where the fixing device 70 that is in the in-use position is located outside the first space.

In the present embodiment, as illustrated in FIG. 6, when the door 20 is closed, at least part of the duplex conveyance path 20a overlaps the first space. Specifically, with the door 20 closed, at least part of the duplex conveyance path 20a is located inside the first space.

As described above, at least part of the fixing device 70 that is in the in-use position is located inside the first space. Therefore, when the fixing device 70 is in the in-use position, the tray unit 50 is prevented from moving from the first inside position to the first outside position. Instead, the fixing device 70 is retractable from the in-use position. With the fixing device 70 retracted from the in-use position, the tray unit 50 is allowed to move from the first inside position to the first outside position. When the tray unit 50 moves from the first inside position to the first outside position, the tray unit 50 travels below the fixing device 70. The fixing device 70 both when in the in-use position and when in the retracted position is located outside the second space. Therefore, both when the fixing device 70 is in the in-use position and when the fixing device 70 is in the retracted position, the transfer unit 40 is allowed to move from the second inside position to the second outside position. When the transfer unit 40 moves from the second inside position to the second outside position, the transfer unit 40 travels below the fixing device 70.

The fixing device 70 includes a fixing frame 70a, which supports the fixing unit 70b. When the fixing device 70 retracts from the in-use position, the fixing frame 70a is displaced relative to the apparatus body 1A while supporting the fixing unit 70b.

To draw the tray unit 50 to the outside of the apparatus body 1A, the door 20 is first moved to the open position as illustrated in FIG. 2. In Example 1, with the fixing device 70 being in the in-use position, the door 20 is allowed to move between the open position and the closed position. With the door 20 being in the open position, the fixing device 70 is moved from the in-use position to the retracted position, as illustrated in FIG. 3, in such a manner as to move to the outside of the first space.

In the printer 1 according to Example 1, the fixing device 70 is movable between the in-use position and the retracted position that is retracted from the in-use position while being kept attached to the apparatus body 1A. In the present embodiment, when the fixing device 70 is in the retracted position, the entirety of the fixing device 70 is located outside the first space.

To move the fixing device 70 to the retracted position that is above the in-use position, the fixing device 70 is lifted upward from the in-use position. That is, the retracted position is higher than the in-use position. As illustrated in FIG. 7, when the fixing device 70 is in the retracted position, at least part of the fixing device 70 projects from the apparatus body 1A to the outside of the apparatus body 1A. When the fixing device 70 is in the retracted position, at least part of the fixing device 70 is located higher than the upper cover portion 20b of the door 20 that is in the closed position. Therefore, in a vertical direction V, while the size of the printer 1 with the fixing device 70 being in the in-use position is kept small, a satisfactory space for the tray unit 50 to move is produced with the movement of the fixing device 70 to the retracted position. When the fixing device 70 is in the retracted position, the door 20 is prevented from taking the closed position.

Specifically, the printer 1 includes a coupling member (fixing coupling member, fixing link, or arm) 75, which is movably attached to the apparatus body 1A. The fixing device 70 is coupled to the apparatus body 1A by the coupling member 75.

The coupling member 75 is rotatable about a pivot 75A. With the movement of the tray unit 50 to the outside of the apparatus body 1A, the coupling member 75 is moved to the outside of the first space. The fixing device 70 is rotatably connected to one end of the coupling member 75. The coupling member 75 is connected at the other end thereof to the apparatus body 1A in such a manner as to be rotatable about the pivot 75A. With the fixing device 70 supported by the coupling member 75 (with the fixing device 70 coupled to the apparatus body 1A by the coupling member 75), the fixing device 70 is movable from the in-use position to the retracted position and from the retracted position to the in-use position. The coupling member 75 is movable (swingable) relative to the apparatus body 1A and the fixing device 70. That is, the fixing device 70 is connected to the apparatus body 1A with the aid of the coupling member 75. Thus, the amount of travel of the fixing device 70 moving between the retracted position and the in-use position is made greater than in a configuration where the fixing device 70 is directly connected to the apparatus body 1A.

As illustrated in FIG. 7, in the movement of the tray unit 50 from the first inside position to the first outside position, the angle formed between the direction of travel of the tray unit 50 and the horizontal direction H is smaller than the angle formed between the direction of travel of the tray unit 50 and the vertical direction V. Furthermore, in the movement of the fixing device 70 from the in-use position to the retracted position, the amount of travel of the fixing device 70 is greater in the vertical direction V than in the horizontal direction H. In other words, in the movement of the fixing device 70 from the in-use position to the retracted position, the amount of travel of the fixing device 70 is greater in a direction perpendicular to the direction of travel of the tray unit 50 than in a direction parallel to the direction of travel of the tray unit 50.

The movement of the fixing device 70 between the in-use position and the retracted position may be realized with the aid of a guide that is fixed to the apparatus body 1A and with which the fixing device 70 is attached to the apparatus body 1A. Such a guide may have any shape.

The method of moving the fixing device 70 to the outside of the first space is not limited to the above.

For example, the fixing device 70 may be detachable from the apparatus body 1A in such a manner as to move away from the in-use position, whereby the fixing device 70 may be moved to the outside of the first space. That is, to bring the fixing device 70 to the outside of the first space, the fixing device 70 may be separated from the apparatus body 1A and from the door 20 (from the main frame 100). Alternatively, the fixing device 70 may be coupled to the door 20. In that case, opening the door 20 moves the fixing device 70 to the outside of the first space.

### Relationship Between Tray Unit and Transfer Unit

Referring to FIGS. 1, 2, 3, 4, 5, 6, and 7, the relationship between the tray unit 50 and the transfer unit 40 will now be described.

As illustrated in FIG. 3, with the fixing device 70 positioned outside the first space, the user grabs the tray handle 52 of the tray unit 50 and moves the tray unit 50 to the outside of the apparatus body 1A.

Referring to FIGS. 6 and 7, in the image forming operation that is performed on the sheet S, the transfer unit 40 and the first space are in the following relationship.

In the image forming operation that is performed on the sheet S, the transfer unit 40 is in the second inside position. As illustrated in FIGS. 6 and 7, at least part of the transfer unit 40 that is in the second inside position overlaps the first space. In other words, when the transfer unit 40 is in the second inside position, at least part of the transfer unit 40 is located inside the first space.

In Example 1, at least part of the transfer unit 40 overlaps the space through which the tray 51 travels along with the movement of the tray unit 50 from the first inside position to the first outside position. Alternatively, at least part of the transfer unit 40 may overlap the space through which the cartridges P travel.

In such an arrangement, the apparatus body 1A can have a smaller size than in an arrangement where the transfer unit 40 that is in the second inside position is located outside the first space.

In the printer 1 according to Example 1, the part of the transfer unit 40 that overlaps the first space is the cleaner 43 including the cleaning member 43A. Alternatively, another part of the transfer unit 40 may overlap the first space. In Example 1, the cleaning member 43A included in the transfer unit 40 that is in the second inside position overlaps the first space.

It can be stated that the tray unit 50 and the transfer unit 40 satisfy the following relationship.

When the tray unit 50 is in the first inside position and the transfer unit 40 is in the second inside position, a part (the cleaner 43) of the transfer unit 40 is located on the downstream side relative to the tray unit 50 in the direction of travel of the tray unit 50 moving from the first inside position to the first outside position. Furthermore, with respect to the vertical direction V, the area (range) where the part (the cleaner 43) of the transfer unit 40, which is located on the downstream side relative to the tray unit 50, is disposed at least partially overlaps the area (range) where the tray unit 50 is disposed.

In the present embodiment, when the door 20 is in the closed position, at least part of the duplex conveyance path 20a overlaps the second space through which the transfer unit 40 is to travel when moving from the second inside position to the second outside position. That is, when the door 20 is in the closed position, at least part of the duplex conveyance path 20a is located inside the second space.

As described above, when the transfer unit 40 is in the second inside position, at least part of the transfer unit 40 is located inside the first space. Therefore, in Example 1, when the user moves the tray unit 50 relative to the apparatus body 1A from the first inside position to the first outside position, the transfer unit 40 is also moved relative to the apparatus body 1A from the second inside position to the second outside position. That is, with the transfer unit 40 caught by the tray unit 50, the tray unit 50 moves from the first inside position to the first outside position, and the transfer unit 40 moves from the second inside position to the second outside position.

Moving the tray unit 50 and the transfer unit 40 altogether reduces the probability that the photoconductor drums 61 may be exposed with the movement of the tray unit 50 to the first outside position and thus reduces the probability that the photoconductor drums 61 may be scratched and/or contaminated.

As illustrated in FIG. 7, with the door 20 being open and the tray unit 50 and the transfer unit 40 being in the first outside position and the second outside position, respectively, the transfer unit 40 supports the tray unit 50 from below the tray unit 50. Furthermore, in the present embodiment, the door 20 supports the transfer unit 40. That is, the transfer unit 40 supported by the door 20 supports the tray unit 50. Such a state may also be expressed that the door 20 supports the tray unit 50 with the transfer unit 40 interposed in between.

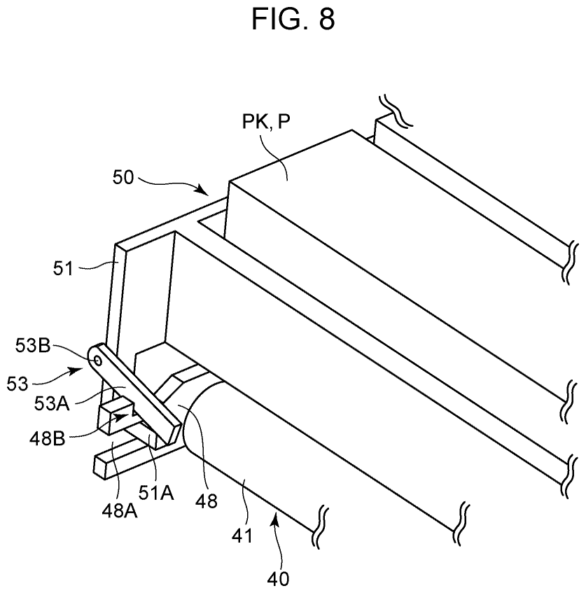

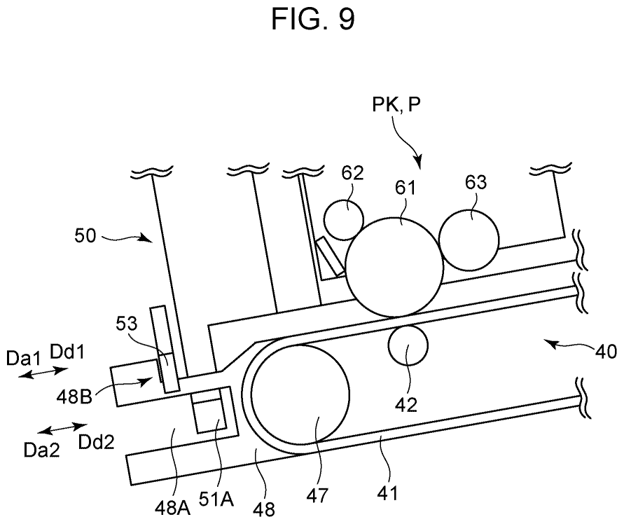

A configuration that enables the tray unit 50 and the transfer unit 40 to move together will now be described with reference to FIGS. 8, 9, and 10. FIGS. 8, 9, and 10 illustrate a coupling member (lever, stopper, or locking member) 53, which couples the tray 51 of the tray unit 50 and the transfer unit 40 to each other.

The printer 1 according to Example 1 includes the locking member 53. In Example 1, the locking member 53 is provided on the tray 51 of the tray unit 50. The locking member 53 includes a transfer locker 53A and is rotatable about a pivot 53B.

The tray 51 includes a transfer coupler 51A. The transfer unit 40 includes a transfer frame 48, which supports the driving roller 46, the tension roller 47, and the primary transfer roller 42. The transfer frame 48 has a tray coupling groove 48A and a locker coupler 48B.

The locking member 53 that is rotatable about the pivot 53B is movable between a coupling position and a releasing position. In the coupling position, the transfer locker 53A is in engagement with the locker coupler 48B, whereby the transfer unit 40 and the tray unit 50 are coupled to each other. The releasing position is retracted from the coupling position.

With the transfer coupler 51A being in engagement with the tray coupling groove 48A, the tray unit 50 is prevented from moving relative to the transfer unit 40 in the first detaching direction (tray detaching direction) Dd1 and in a direction orthogonal to the first detaching direction Dd1. Meanwhile, the transfer unit 40 is prevented from moving relative to the tray unit 50 in the second attaching direction (transfer attaching direction) Da2 and in a direction orthogonal to the second attaching direction Da2.

A configuration similar to the above is provided at each of the following four locations: locations near two respective ends of the tension roller 47 in the direction of the rotation axis of the tension roller 47, and locations near two respective ends of the driving roller 46 in the direction of the rotation axis of the driving roller 46.

With the transfer locker 53A of the locking member 53 that is in the coupling position being in engagement with the locker coupler 48B, the tray unit 50 is prevented from moving relative to the transfer unit 40 in the first attaching direction (tray attaching direction) Da1. Meanwhile, the transfer unit 40 is prevented from moving relative to the tray unit 50 in the second detaching direction (transfer detaching direction) Dd2.

The locking member 53 and the locker coupler 48B may also be provided at each of the two ends of the transfer unit 40 in the direction of the rotation axis of the tension roller 47.

That is, with the transfer coupler 51A being in engagement with the tray coupling groove 48A and with the locking member 53 that is in the coupling position being in engagement with the locker coupler 48B, the transfer unit 40 and the tray unit 50 are prevented from moving relative to each other. The transfer unit 40 and the tray unit 50 in such a state may have play in between.

It can also be stated that the transfer coupler 51A and the locking member 53 serve as a tray-side coupling device, and the tray coupling groove 48A and the locking member 48B serve as a transfer-side coupling device. Coupling the tray-side coupling device and the transfer-side coupling device to each other couples the tray unit 50 and the transfer unit 40 to each other, whereby the tray unit 50 and the transfer unit 40 are enabled to move together.

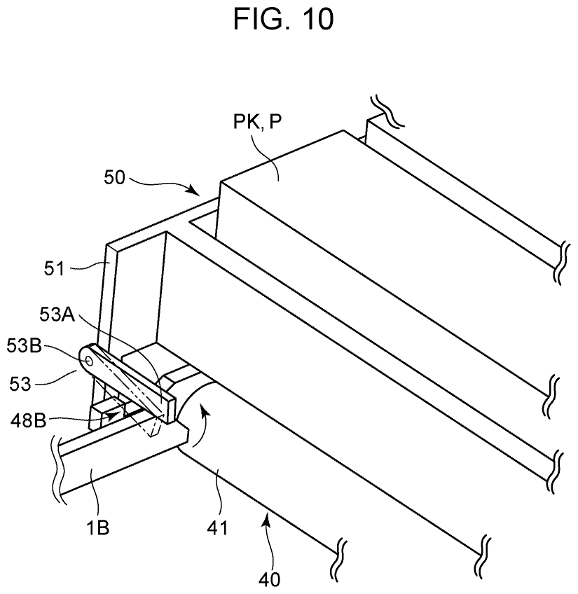

As illustrated in FIG. 10, the apparatus body 1A includes an unlocker 1B. With the tray unit 50 being in the first inside position and the transfer unit 40 being in the second inside position, the locking member 53 is in contact with the unlocker 1B, that is, the locking member 53 is in the releasing position. In such a state, the transfer locker 53A is away from the locker coupler 48B.

With the locking member 53 being in the releasing position, when the tray unit 50 is moved in the first detaching direction Dd1, the transfer coupler 51A pushes the transfer unit 40 in the second detaching direction Dd2. Accordingly, the transfer unit 40 moves together with the tray unit 50 in the second detaching direction Dd2. When the tray unit 50 moves by a predetermined distance in the first detaching direction Dd1, the locking member 53 moves away from the unlocker 1B to the coupling position and engages with the locker coupler 48B. With the locking member 53 moved to the coupling position and thus being in engagement with the locker coupler 48B, the tray unit 50 and the transfer unit 40 are moved to the first outside position and the second outside position, respectively.

With the locking member 53 being in engagement with the locker coupler 48B, when the tray unit 50 is moved in the first attaching direction Da1, the locking member 53 pushes the transfer unit 40 in the second attaching direction Da2. Accordingly, the transfer unit 40 moves together with the tray unit 50 in the second attaching direction Da2.

With the locking member 53 being in engagement with the locker coupler 48B, when the transfer unit 40 is moved in the second attaching direction Da2, the transfer unit 40 pushes the transfer coupler 51A, whereby the tray unit 50 is pushed in the first attaching direction Da1. Accordingly, the tray unit 50 moves together with the transfer unit 40 in the first attaching direction Da1.

When the tray unit 50 and the transfer unit 40 are moved altogether toward the inside of the apparatus body 1A, the unlocker 1B moves the locking member 53 to the releasing position. In such a state, the transfer unit 40 does not move even if the tray unit 50 is moved in the first attaching direction Da1. Instead, in the process of closing the door 20, a force that brings the secondary transfer roller 45 into contact with the transfer unit 40 pushes the transfer unit 40 in the second attaching direction Da2 deeply (to the second inside position) inside the apparatus body 1A. That is, the door 20 is able to push the transfer unit 40 to bring the transfer unit 40 to the second inside position. Alternatively, the door 20 may push the tray unit 50 to bring the tray unit 50 to the first inside position.

On the other hand, with the locking member 53 being in the releasing position and the tray unit 50 being in the first inside position, when the transfer unit 40 is moved in the second detaching direction Dd2, the transfer unit 40 is allowed to move independently of the tray unit 50 from the second inside position to the second outside position. In the printer 1 according to Example 1, as illustrated in FIG. 5, the transfer unit 40 is allowed to move to the outside (the second outside position) of the apparatus body 1A with the tray unit 50 remaining on the inside (at the first inside position) of the apparatus body 1A. Therefore, the transfer unit 40 is detachable from the apparatus body 1A and is replaceable with a fresh transfer unit 40.

In Example 1, when the tray unit 50 is in the first inside position, the position of the tray unit 50 is determined relative to the apparatus body 1A independently of the transfer unit 40. Furthermore, when the transfer unit 40 is in the second inside position, the position of the transfer unit 40 is determined relative to the apparatus body 1A independently of the tray unit 50. This is because of priority for accurate positioning of each of the transfer unit 40 and the tray unit 50 relative to the apparatus body 1A. Therefore, when the tray unit 50 is in the first inside position and the transfer unit 40 is in the second inside position, a small clearance is provided between the tray coupling groove 48A and the transfer coupler 51A.

To enable the positioning of the tray unit 50 and the transfer unit 40 relative to each other with the tray unit 50 being in the first inside position and the transfer unit 40 being in the second inside position, the clearance between the tray coupling groove 48A and the transfer coupler 51A may be eliminated. In that case, the accuracy of positioning of the transfer unit 40 and the tray unit 50 relative to each other is increased.

### How Tray Unit and Transfer Unit Move

As illustrated in FIGS. 1, 6, and 7, the tray unit 50 and the transfer unit 40 when attached to the apparatus body 1A are inclined relative to the horizontal direction H.

More specifically, when the tray unit 50 is in the first inside position, the rotation axes of those photoconductor drums 61 that are closer to the first end portion 1b1 lie higher in the vertical direction V than the rotation axes of those photoconductor drums 61 that are farther from the first end portion 1b1.

That is, when the tray unit 50 is in the first inside position, the second photoconductor drum is located closer to the first end portion 1b1 than the first photoconductor drum is to the first end portion 1b1, and the rotation axis of the second photoconductor drum lies higher in the vertical direction V than the rotation axis of the first photoconductor drum. Likewise, the third photoconductor drum is located closer to the first end portion 1b1 than the second photoconductor drum is to the first end portion 1b1, and the rotation axis of the third photoconductor drum lies higher in the vertical direction V than the rotation axis of the second photoconductor drum. The fourth photoconductor drum is located closer to the first end portion 1b1 than the third photoconductor drum is to the first end portion 1b1, and the rotation axis of the fourth photoconductor drum lies higher in the vertical direction V than the rotation axis of the third photoconductor drum.

When the tray unit 50 is in the first inside position, at least part of each of those cartridges P that are located closer to the first end portion 1b1 is located higher in the vertical direction V than those cartridges P that are located farther from the first end portion 1b1.

That is, when the tray unit 50 is in the first inside position, the cartridge PC is located closer to the first end portion 1b1 than the cartridge PK, and at least part of the cartridge PC is located higher in the vertical direction V than the cartridge PK. Likewise, the cartridge PM is located closer to the first end portion 1b1 than the cartridge PC, and at least part of the cartridge PM is located higher in the vertical direction V than the cartridge PC. The cartridge PY is located closer to the first end portion 1b1 than the cartridge PM, and at least part of the cartridge PY is located higher in the vertical direction V than the cartridge PM.

Referring to FIG. 1, a straight line connecting the centers of the photoconductor drums 61 to one another is denoted as a line LD. In Example 1, when the tray unit 50 is in the first inside position, the line LD is inclined upward relative to the horizontal direction H from the side farther from the first end portion 1b1 toward the side closer to the first end portion 1b1.

Furthermore, the contact surface of the belt 41 that is in contact with the first photoconductor drum, the second photoconductor drum, the third photoconductor drum, and the fourth photoconductor drum is inclined upward from the side farther from the first end portion 1b1 toward the side closer to the first end portion 1b1.

The direction of travel of the tray unit 50 moving from the first inside position to the first outside position is referred to as a drawing direction for the tray unit 50. When the tray unit 50 is in the first inside position, the tray unit 50 is inclined such that a downstream portion of the tray unit 50 in the drawing direction for the tray unit 50 is located higher in the vertical direction V than an upstream portion of the tray unit 50. In other words, the tray unit 50 is inclined obliquely upward relative to the horizontal direction H toward the downstream side in the drawing direction.

Likewise, the direction of travel of the tray 51 of the tray unit 50 moving from the first inside position to the first outside position is referred to as a drawing direction for the tray 51. When the tray 51 is in the first inside position, the tray 51 is inclined such that a downstream portion of the tray 51 in the drawing direction for the tray 51 is located higher in the vertical direction V than an upstream portion of the tray 51. In other words, the tray 51 is inclined obliquely upward relative to the horizontal direction H toward the downstream side in the drawing direction.

As illustrated in FIG. 1, the tray 51 has a tray lower surface 51c. The tray lower surface 51c faces downward when the tray unit 50 is in the first inside position. More specifically, the tray lower surface 51c refers to the largest one of the surfaces of the tray 51 that face downward when the tray unit 50 is in the first inside position. The tray lower surface 51c has a downstream end 51c1 and an upstream end 51c2, which are with respect to the drawing direction for the tray unit 50. When the tray unit 50 moves from the first inside position to the first outside position, the downstream end 51c1 is located downstream of the upstream end 51c2. In Example 1, when the tray unit 50 is in the first inside position, the tray lower surface 51c is inclined upward relative to the horizontal direction H from the side farther from the first end portion 1b1 toward the side closer to the first end portion 1b1. Furthermore, in the vertical direction V, the downstream end 51c1 is located higher than the upstream end 51c2.

When the tray unit 50 moves from the first inside position to the first outside position, the tray unit 50 travels in a direction inclined relative to the horizontal direction H (in the present embodiment, a direction inclined upward relative to the horizontal direction H). That is, when the tray unit 50 moves from the first inside position to the first outside position, the tray unit 50 travels obliquely upward.

During the movement of the tray unit 50 from the first inside position to the first outside position, the direction of travel of the tray unit 50 changes downward from the obliquely upward direction. The direction of travel of the tray unit 50 may include a direction parallel to the horizontal direction H or an obliquely downward direction relative to the horizontal direction H.

The angle formed between the line LD and the horizontal direction H is smaller when the tray unit 50 is in the first outside position than when the tray unit 50 is in the first inside position. When the tray unit 50 is in the first outside position, although the line LD and the horizontal direction H in Example 1 are parallel to each other, the line LD may alternatively be inclined downward or upward relative to the horizontal direction H.

Likewise, during the movement of the transfer unit 40 from the second inside position to the second outside position, the direction of travel of the transfer unit 40 changes downward from the obliquely upward direction. The direction of travel of the transfer unit 40 may include a direction parallel to the horizontal direction H or an obliquely downward direction relative to the horizontal direction H.

The angle formed between the contact surface of the belt 41 and the horizontal direction H is smaller when the transfer unit 40 is in the second outside position than when the transfer unit 40 is in the second inside position. When the transfer unit 40 is in the second outside position, although the contact surface of the belt 41 and the horizontal direction H in Example 1 are parallel to each other, the contact surface of the belt 41 may alternatively be inclined downward or upward relative to the horizontal direction H.

In the movement of the tray unit 50 from the first outside position to the first inside position, the tray unit 50 first travels in the horizontal direction H and then travels obliquely downward. In the movement of the transfer unit 40 from the second outside position to the second inside position, the transfer unit 40 first travels in the horizontal direction H and then travels obliquely downward. In such a configuration, the weights of the tray unit 50 and the transfer unit 40 themselves can be utilized in inserting the tray unit 50 and the transfer unit 40 into the apparatus body 1A.

The above horizontal direction H may also be referred to as a first direction that is orthogonal to the vertical direction V. The first direction is a direction intersecting (preferably orthogonal to) the direction of the rotation axes of the photoconductor drums 61 and is a direction intersecting (preferably orthogonal to) the direction of the rotation axis of the driving roller 46. A direction that is orthogonal to both the horizontal direction H and the vertical direction V may also be referred to as a second direction. The second direction is parallel to the direction of the rotation axis of the driving roller 46 and to the direction of the rotation axes of the photoconductor drums 61. It can be stated that FIGS. 1 to 7 each illustrate the printer 1 seen in the second direction. The second direction may also be referred to as the widthwise direction of the sheet S.

Hereinafter, in the vertical direction V, the upper side of the printer 1 is referred to as the top-face side, and the lower side of the printer is referred to as the bottom-face side. In the horizontal direction H, one side of the printer 1 is referred to as the front-face side, and the other side of the printer 1 is referred to as the rear-face side. The first end portion 1b1 is located on the front-face side, and the second end portion 1b2 is located on the rear-face side. Seeing the printer 1 from the front-face side, the right side and the left side of the printer in the second direction are referred to as the right-face side and the left-face side, respectively.

### How Electric Components are Supported

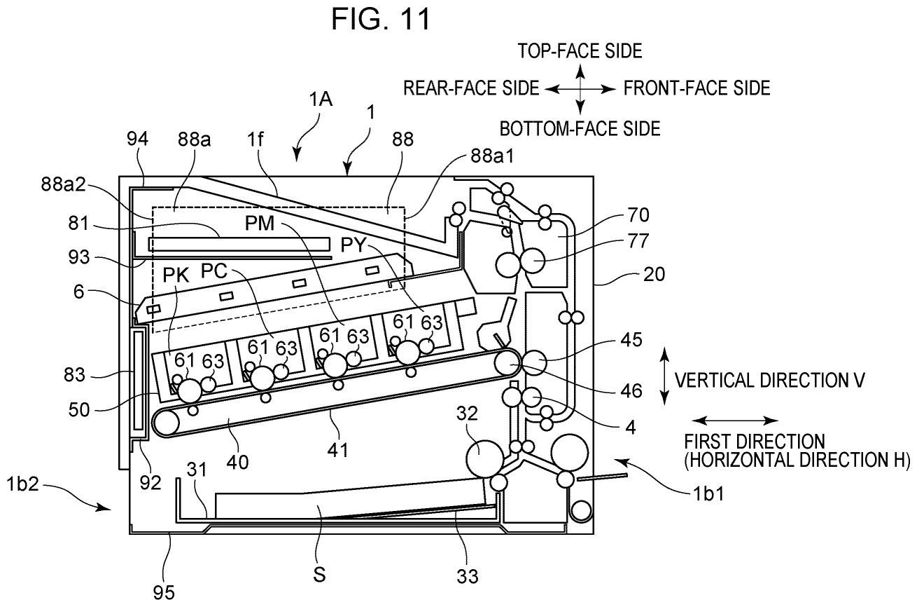

Referring to FIGS. 11 to 13, the layout of electric components included in the printer 1 will now be described. The electric components include a power source board that receives an alternating-current voltage from a commercial power source, electric boards such as a control board that controls operations of relevant elements included in the printer 1, and drive sources.

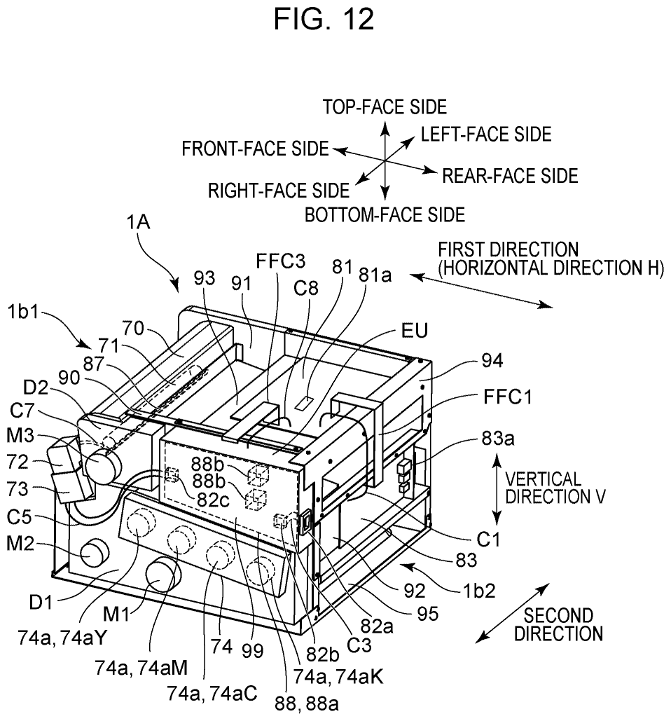

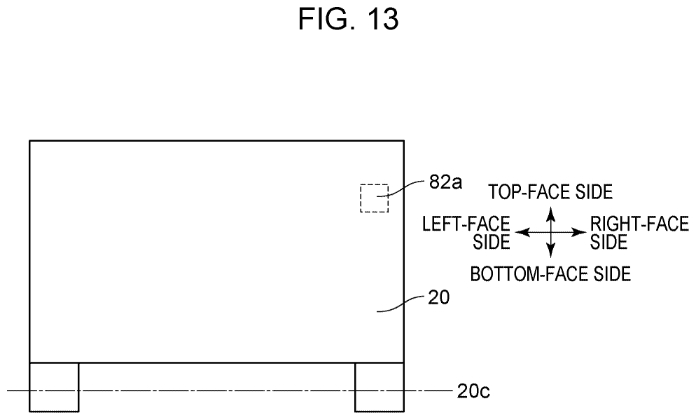

FIGS. 11 and 12 illustrate the positions of the electric components included in the printer 1 according to Example 1. In FIG. 12, exterior members, such as the door 20, of the apparatus body 1A of the printer 1 are not illustrated. FIG. 13 illustrates the positions of the door 20 and an inlet 82a, which will be described below, according to Example 1.

As illustrated in FIG. 12, the apparatus body 1A includes a right side plate (first side wall) 90, which is located at one end in the second direction; and a left side plate (second side wall) 91, which is located at the other end in the second direction. The right side plate 90 and the left side plate 91 support the tray unit 50 that is in the first inside position. The right side plate 90 and the left side plate 91 also support the transfer unit 40 that is in the second inside position. The right side plate 90 and the left side plate 91 are each made of sheet metal.

The tray unit 50 is movable between the first inside position and the first outside position in such a manner as to move relative to the right side plate 90 and the left side plate 91 in a direction intersecting (preferably orthogonal to) the second direction.

The transfer unit 40 is movable between the second inside position and the second outside position in such a manner as to move relative to the right side plate 90 and the left side plate 91 in a direction intersecting (preferably orthogonal to) the second direction. The right side plate 90 and the left side plate 91 include guide parts where the tray unit 50 and the transfer unit 40 are guided while moving.

As illustrated in FIGS. 11 and 12, the apparatus body 1A includes a first rear stay 92 and a second rear stay 94. The first rear stay 92 and the second rear stay 94 are each an exemplary rear wall. In the first direction, the first rear stay 92 and the second rear stay 94 are located closer to the second end portion 1b2 than to the first end portion 1b1. More specifically, the first rear stay 92 is located at the second end portion 1b2, and at least part of the first rear stay 92 is located between the right side plate 90 and the left side plate 91 in the second direction. The second rear stay 94 is located at the second end portion 1b2, and at least part of the second rear stay 94 is located between the right side plate 90 and the left side plate 91 in the second direction. The first rear stay 92 and the second rear stay 94 are each made of sheet metal.

The first rear stay 92 is fixed to at least one of the right side plate 90 and the left side plate 91. The second rear stay 94 is fixed to at least one of the right side plate 90 and the left side plate 91. In the present embodiment, the first rear stay 92 is fixed to both the right side plate 90 and the left side plate 91, and the second rear stay 94 is fixed to both the right side plate 90 and the left side plate 91. In the present embodiment, the first rear stay 92 is fixed to the second rear stay 94.

As illustrated in FIG. 11, the apparatus body 1A includes an upper stay 93. The upper stay 93 is an exemplary upper wall. In the first direction, the upper stay 93 is located closer to the second end portion 1b2 than to the first end portion 1b1. At least part of the upper stay 93 is located between the right side plate 90 and the left side plate 91 in the second direction. The upper stay 93 is fixed to at least one of the right side plate 90 and the left side plate 91. In the present embodiment, the upper stay 93 is fixed to both the right side plate 90 and the left side plate 91. The upper stay 93 is made of sheet metal.

When the tray unit 50 is in the first inside position, at least part of the tray unit 50 is located below the upper stay 93. In the present embodiment, the entirety of the tray unit 50 is located below the upper stay 93, and at least part of the scanner 6 is located below the upper stay 93.

With respect to the first direction, the location (position) of the upper stay 93 and the location (position) of the tray unit 50 at least partially overlap each other. That is, at least part of the tray unit 50 that is in the first inside position is located directly below the upper stay 93.

With respect to the first direction, the location (position) of the upper stay 93 and the location (position) of the scanner 6 at least partially overlap each other. That is, at least part of the scanner 6 is located directly below the upper stay 93.

As illustrated in FIG. 11, the apparatus body 1A includes a bottom plate 95. The bottom plate 95 is an exemplary bottom wall. At least part of the bottom plate 95 is located between the right side plate 90 and the left side plate 91 in the second direction. The bottom plate 95 is fixed to at least one of the right side plate 90 and the left side plate 91. In the present embodiment, the bottom plate 95 is fixed to both the right side plate 90 and the left side plate 91.

The right side plate 90, the left side plate 91, the first rear stay 92, the second rear stay 94, the upper stay 93, and the bottom plate 95 may each be fixed to a corresponding element by way of screwing, welding, or the like.

The printer 1 includes an imaging motor M1, a sheet feeding motor M2, and a fixing motor M3. The imaging motor M1, the sheet feeding motor M2, and the fixing motor M3 are each an exemplary drive source.

The sheet feeding motor M2 is configured to drive the inner plate 33 such that the sheets S on the stacking tray 31 are lifted to reach the feed roller 32. The sheet feeding motor M2 is also configured to drive the feed roller 32.

The sheet feeding motor M2 is provided on the right side plate 90.

The printer 1 includes a fixing drive unit D2, which includes the fixing motor M3. The fixing drive unit D2 is provided on the right side plate 90. The fixing motor M3 is configured to drive the pressure roller (fixing roller) 77 included in the fixing device 70. The fixing drive unit D2 may include a fixing drive train (fixing gear train) configured to transmit the driving force of the fixing motor M3 to the pressure roller 77.

The printer 1 includes an imaging drive unit D1, which includes the imaging motor M1 and an imaging drive train (imaging gear train) 74. The imaging drive train 74 is configured to transmit the driving force of the imaging motor M1 to the tray unit 50. The imaging drive unit D1 is provided on the right side plate 90. In the present embodiment, the imaging motor M1 is configured to drive the driving roller 46 of the transfer unit 40 and so forth.

In the present embodiment, the imaging drive train 74 is configured to transmit the driving force of the imaging motor M1 to the photoconductor drums 61 of the yellow station, the magenta station, the cyan station, and the black station. The imaging drive train 74 may be configured to transmit the driving force of the imaging motor M1 to the developing rollers 63 of the yellow station, the magenta station, the cyan station, and the black station. The imaging drive train 74 may be configured to transmit the driving force of the imaging motor M1 to both the developing rollers 63 and the photoconductor drums 61 of the yellow station, the magenta station, the cyan station, and the black station.

The imaging drive train 74 includes drive output parts 74a. When the tray unit 50 is in the first outside position, the drive output parts 74a are out of connection with the tray unit 50. When the tray unit 50 is in the first inside position and an image forming operation is to be performed on a sheet S, the drive output parts 74a are connected to the tray unit 50 so that the driving force of the imaging motor M1 is transmitted to the tray unit 50.

The drive output parts 74a may each be, for example, a gear or a coupling. The imaging drive train 74 includes drive output parts 74aY, 74aM, 74aC, and 74aK.

The drive output part 74aY is configured to transmit the driving force of the imaging motor M1 to the yellow station to drive at least one of the photoconductor drum 61 and the developing roller 63 of the yellow station. If the drive output part 74aY is configured to drive both the photoconductor drum 61 and the developing roller 63, the drive output part 74aY may include a member that drives the photoconductor drum 61 and a member that drives the developing roller 63.

The drive output parts 74aM, 74aC, and 74aK are configured to transmit the driving force of the imaging motor M1 to the magenta station, the cyan station, and the black station, respectively. The drive output parts 74aM, 74aC, and 74aK have the same configuration as the drive output part 74aY.

As illustrated in FIG. 11, the transfer unit 40 is inclined downward toward a side away from the secondary transfer portion in the first direction. Since the transfer unit 40 is inclined downward, a part of the transfer unit 40 is accommodated in a space between the secondary transfer portion and the stacking tray 31 in the vertical direction V. Thus, the size of the printer 1 in the vertical direction V is reduced.

Along with the transfer unit 40 inclined downward, the tray unit 50 is inclined downward toward the side away from the secondary transfer portion in the first direction. Along with the tray unit 50 inclined downward, the direction in which the photoconductor drums 61 are side by side is inclined downward toward the side away from the secondary transfer portion in the first direction. Correspondingly, the scanner 6 is inclined downward toward the side away from the secondary transfer portion in the first direction.

In the present embodiment, when the tray unit 50 is in the first inside position, the photoconductor drum 61 of the cyan station is located closer in the first direction to the first end portion 1b1 than the photoconductor drum 61 of the black station. When the tray unit 50 is in the first inside position, at least part of the photoconductor drum 61 of the cyan station is located higher in the vertical direction V than the photoconductor drum 61 of the black station. The photoconductor drum 61 of the cyan station is an exemplary first rotary body. The photoconductor drum 61 of the black station is an exemplary second rotary body. When the tray unit 50 is in the first inside position, at least part of the photoconductor drum 61 of the black station is located lower in the vertical direction V than the secondary transfer roller 45. The point of contact between the photoconductor drum 61 of the black station and the belt 41 is also located lower in the vertical direction V than the secondary transfer roller 45.

Since the scanner 6 is inclined, the upper stay 93 and an electric board provided on the upper stay 93 are accommodated in a space produced above the scanner 6. In Example 1, the upper stay 93 is provided with a control board 81, which will be described separately below. In Example 1, the control board 81 is an exemplary upper board provided on the upper stay 93.

With respect to the first direction, the location (position) of the electric board provided on the upper stay 93 and the location (position) of the tray unit 50 in the first inside position at least partially overlap each other. That is, at least part of the tray unit 50 that is in the first inside position is located directly below the electric board provided on the upper stay 93.

With respect to the first direction, the location (position) of the electric board provided on the upper stay 93 and the location (position) of the scanner 6 at least partially overlap each other. That is, at least part of the scanner 6 is located directly below the electric board provided on the upper stay 93.

The first rear stay 92 is provided with a connection board 83. In the present embodiment, the first rear stay 92 is bent to have a depression, and the connection board 83 is accommodated in the depression of the first rear stay 92. In Example 1, the connection board 83 is an exemplary rear board provided on the first rear stay 92.

The connection board 83 includes a connector (connection connector or an external connection connector) 83a, which is connectable to the external instrument (external device) 400. Examples of the connector 83a include a local-area-network (LAN) connector and a universal-serial-bus (USB) connector. The external instrument 400 is a device capable of outputting a printing instruction to the printer 1. Examples of the external instrument 400 include a personal computer. The connection board 83 is capable of generating an image signal on the basis of the printing instruction (image information) transmitted from the external instrument 400 connected to the connector 83a with a cable or the like.

The connection board 83 has a mounting surface on which the connector 83a is mounted. The mounting surface of the connection board 83 extends in the vertical direction V. The angle (narrow angle) formed between the mounting surface of the connection board 83 and the vertical direction V may be smaller than 30 degrees. The mounting surface of the connection board 83 and the vertical direction V may be parallel to each other.

The mounting surface of the connection board 83 also extends in the second direction. The angle (narrow angle) formed between the mounting surface of the connection board 83 and the second direction may be smaller than 30 degrees. The mounting surface of the connection board 83 and the second direction may be parallel to each other.

The connection board 83 is connected to the control board 81 with a cable FFC1. The cable FFC1 is a flexible flat cable. The image signal generated by the connection board 83 is transmitted through the cable FFC1 to the control board 81.

The control board 81 includes electric elements 81a. The electric elements 81a included in the control board 81 may be a central processing unit (CPU) and a storage device such as a random access memory (RAM) or a read-only memory (ROM). The control board 81 is configured to receive signals including the image signal outputted from the connection board 83. The control board 81 according to Example 1 is configured to control the imaging motor M1, the sheet feeding motor M2, and the fixing motor M3. The control board 81 includes a CPU and a drive circuit that are configured to control the operations of the imaging motor M1, the sheet feeding motor M2, and the fixing motor M3.

The control board 81 may be configured to control at least one of the imaging motor M1, the sheet feeding motor M2, the fixing motor M3, the fixing device 70, and the scanner 6.

The control board 81 according to Example 1 further has a function of generating high voltages to be supplied to the cartridges P and to the transfer unit 40.

The control board 81 has a mounting surface on which electric elements are mounted. The mounting surface of the control board 81 extends in the first direction. The angle (narrow angle) formed between the mounting surface of the control board 81 and the first direction may be smaller than 30 degrees. The mounting surface of the control board 81 and the first direction may be parallel to each other.

The mounting surface of the control board 81 also extends in the second direction. The angle (narrow angle) formed between the mounting surface of the control board 81 and the second direction may be smaller than 30 degrees. The mounting surface of the control board 81 and the second direction may be parallel to each other.

The printer 1 has an inlet 82a. In the first direction, the inlet 82a is located closer to the second end portion 1b2 than to the first end portion 1b1. A plug or the like intended to connect a commercial power source and the printer 1 to each other is to be inserted into the inlet 82a. That is, the inlet 82a is configured to receive an alternating-current voltage supplied from a commercial power source.

FIG. 13 illustrates the printer 1 seen in the first direction. More specifically, FIG. 13 is a front view of the printer 1. In FIG. 13, the door 20 is in the closed position. As viewed in the first direction, the inlet 82a overlaps the door 20 that is in the closed position. The inlet 82a is located higher in the vertical direction V than a rotation axis 20c of the door 20.

In Example 1, the inlet 82a is open in the first direction, more specifically, in a direction from the first end portion 1b1 toward the second end portion 1b2. The inlet 82a is located closer to the top of the apparatus body 1A than to the bottom of the apparatus body 1A. That is, the apparatus body 1A has an upper end and a lower end with respect to the vertical direction V, and the inlet 82a is located closer in the vertical direction V to the upper end than to the lower end.

The right side plate 90 is provided with a power source unit EU. The power source unit EU includes a power source board 88 and a power-source-board stay 99. The power-source-board stay 99 serves as a casing that houses the power source board 88. The power source board 88 is supported by the power-source-board stay 99 and is fixed to the right side plate 90 with the aid of the power-source-board stay 99. In Example 1, the inlet 82a is supported by the power-source-board stay 99.

In the first direction, at least a part of the power source board 88 is located closer to the second end portion 1b2 than the fixing device 70 and is located closer to the first end portion 1b1 than the inlet 82a.

The power source board 88 is supplied with an alternating-current voltage from a commercial power source through the inlet 82a.

In other words, the power source board 88 is configured to receive an alternating-current voltage supplied from a commercial power source through the inlet 82a.

The power source board 88 includes a wiring board 88a and at least one electric element 88b, which is mounted on the mounting surface of the wiring board 88a. The at least one electric element 88b includes a plurality of electric elements. Examples of the plurality of electric elements include a capacitor and a transformer.

The mounting surface of the wiring board 88a (the mounting surface of the power source board 88) extends in the first direction. The angle (narrow angle) formed between the mounting surface of the power source board 88 and the first direction may be smaller than 30 degrees. The mounting surface of the power source board 88 and the first direction may be parallel to each other.

The mounting surface of the power source board 88 also extends in the vertical direction V. The angle (narrow angle) formed between the mounting surface of the power source board 88 and the vertical direction V may be smaller than 30 degrees. The mounting surface of the power source board 88 and the vertical direction V may be parallel to each other.

In Example 1, the mounting surface of the wiring board 88a faces toward the right side plate 90 in the second direction. Therefore, the electric element 88b is located between the right side plate 90 and the wiring board 88a in the second direction.

As illustrated in FIG. 11, as viewed in the second direction, the power source board 88 overlaps the discharge tray (discharge tray) 1f and the scanner 6.

In the first direction, the power source board 88 is located closer to the second end portion 1b2 than to the first end portion 1b1. In the first direction, the power source board 88 has a first board end 88a1 and a second board end 88a2. In the first direction, the first board end 88a1 is located closer to the first end portion 1b1 than the second board end 88a2.

As illustrated in FIG. 12, with respect to the second direction, the location (position) of the power source unit EU (the area (range) where the power source unit EU is disposed) and the location (position) of the imaging drive unit D1 (the area (range) where the imaging drive unit D1 is disposed) overlap each other. In the vertical direction V, the power source unit EU is located higher than the imaging drive unit D1. In the vertical direction V, the power source unit EU is located higher than the imaging drive train 74. In the present embodiment, the power source unit EU is located directly above the imaging drive unit D1 and directly above the imaging drive train 74.

The tray unit 50 is inclined downward toward a side away from the first end portion 1b1 in the first direction. Along with the tray unit 50 inclined downward, the direction in which the photoconductor drums 61 are side by side is inclined downward toward the side away from the first end portion 1b1 in the first direction. Correspondingly, the imaging drive train 74 is inclined downward toward the side away from the first end portion 1b1 in the first direction. Thus, the space above the imaging drive unit D1 is increased near the second end portion 1b2.

In Example 1, the power source unit EU is located above the imaging drive unit D1. That is, the space above the imaging drive unit D1 is efficiently utilized for placing the power source unit EU.

In the vertical direction V, the first board end 88a1 is shorter than the second board end 88a2. Therefore, the length of the power-source-board stay 99 can be made shorter at an end portion thereof closer in the first direction to the first end portion 1b1 than at an end portion thereof closer in the first direction to the second end portion 1b2. Thus, the space produced by inclining the imaging drive train 74 is further efficiently utilized for placing the power source unit EU.

Since an increased space is provided above the imaging drive unit D1, the inlet 82a is allowed to be provided above the imaging drive unit D1. That is, the degree of freedom in the location (position) of the inlet 82a is increased.

The power source board 88 includes a connector 82b. The connector 82b is connected to the inlet 82a with a cable C3. The alternating-current voltage generated by the commercial power source is supplied from the inlet 82a through the cable C3 and the connector 82b to the power source board 88.

The power source board 88 has a function of a so-called AC-DC converter configured to convert an alternating-current voltage into a direct-current voltage. To realize the function, the power source board 88 includes a rectifying element, a smoothing capacitor, a transformer, a switching element, and a control integrated circuit (IC). The rectifying element, the smoothing capacitor, the transformer, the switching element, and the control IC are each an exemplary electric component 88b.

The power source board 88 is configured to supply electrical power to the connection board 83, the control board 81, the imaging motor M1, the sheet feeding motor M2, and the fixing motor M3. More specifically, the power source board 88 is configured to convert commercial-power-source voltages into direct-current voltages of 24 V, 3.3 V, and so forth and to supply the direct-current voltages to the connection board 83, the control board 81, the imaging motor M1, the sheet feeding motor M2, and the fixing motor M3. The imaging motor M1, the sheet feeding motor M2, and the fixing motor M3 are each an exemplary drive source that is driven with the power supplied from the power source board 88.

In Example 1, the power source board 88 and the control board 81 are connected to each other with a cable C8. The direct-current voltages of 24 V and 3.3 V are supplied to the control board 81 through the cable C8.

In Example 1, the power source board 88 and the control board 81 are connected to each other with a cable FFC3. The cable FFC3 is a flexible flat cable. A signal for controlling the operation of the power source board 88 is transmitted from the control board 81 to the power source board 88 through the cable FFC3. The signal includes a signal for changing the operation mode of the AC-DC converter of the power source board 88 when the printer 1 goes into a power-saving mode.

In Example 1, the control board 81 and the connection board 83 are connected to each other with a cable C1. The direct-current voltage of 3.3 V is supplied from the control board 81 through the cable C1 to the connection board 83, whereby a control element (such as a central processing unit or processor) and so forth included in the connection board 83 are activated.

In Example 1, the power source board 88 is configured to supply electrical power to the fixing device 70. More specifically, the heating roller 71 of the fixing device 70 includes a heater 87, and the power source board 88 supplies power to the heater 87.

The power source board 88 is configured to control a triac to be turned on and off in such a manner as to exert a function of converting a commercial-power-source voltage into a desired fixing-power-source voltage and supplying the converted voltage to the heater 87. The commercial-power-source voltage, which is to be converted in Example 1, may be the alternating-current voltage that is received as is from the commercial power source or may be a voltage obtained through a current fuse and/or a noise filter (not illustrated).

To supply a desired power to the fixing device 70, the power source board 88 carries a switching element such as a triac, a circuit configured to activate the triac, a circuit configured to detect the period and/or phase of the commercial-power-source voltage, and so forth. With the triac controlled to be turned on and off, the commercial-power-source voltage (alternating-current voltage) is converted into a desired fixing-power-source voltage before being supplied to the heater 87.

The fixing device 70 includes a receiving connector (fixing connector) 72, which is to receive power from the power source board 88. The receiving connector 72 is connected to the heater 87 with a cable C7. On the other hand, the apparatus body 1A is provided with a supply connector 73 and a cable C5. The cable C5 is connected to a connector 82c, which is provided on the power source board 88. In the first direction, the connector 82c is located closer to the fixing device 70 than the inlet 82a.

The supply connector 73 is electrically connected to the power source board 88 through the cable C5 and the connector 82c. The receiving connector 72 is detachably connected to the supply connector 73.

In the second direction, the receiving connector 72 and the supply connector 73 are located closer to the right side plate 90 than to the left side plate 91. In the first direction, the receiving connector 72 and the supply connector 73 are located closer to the first end portion 1b1 than to the second end portion 1b2.

The power is supplied from the power source board 88 to the heater 87 through the connector 82c, the cable C5, the supply connector 73, the receiving connector 72, and the cable C7.

Through the cable FFC3 that connects the power source board 88 and the control board 81 to each other, a signal for detecting the phase of the commercial-power-source voltage is transmitted to the control board 81, and a heater control signal generated by the control board 81 from the phase of the commercial-power-source voltage is transmitted to the power source board 88. On the basis of the heater control signal, the triac is controlled to be turned on and off to supply electrical power to the heater 87 such that the heater 87 comes to have a desired temperature corresponding to the characteristic of the sheet S and/or the printing speed.

### Position of Power Source Unit

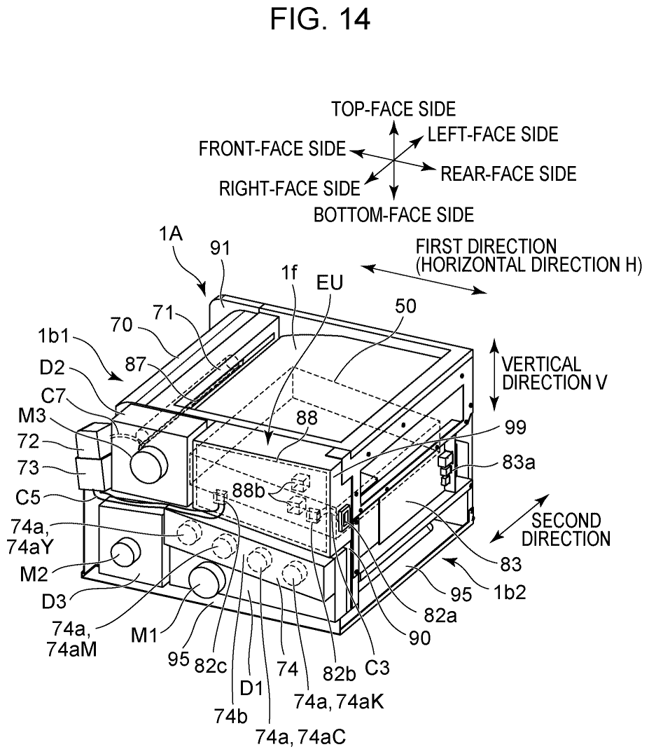

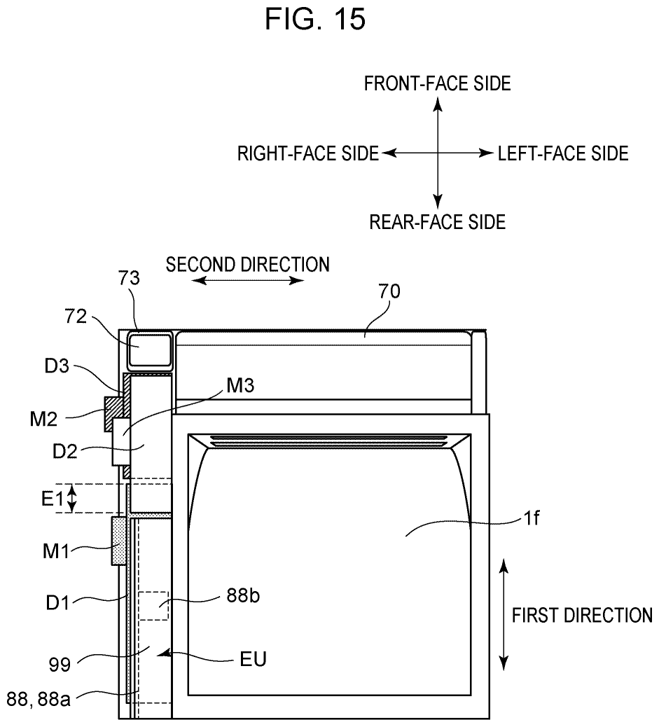

Referring to FIGS. 14 and 15, the position of the power source unit EU will further be described in detail.

FIGS. 14 and 15 illustrate the position of the power source unit EU according to Example 1.

The printer 1 including the imaging drive unit D1 and the fixing drive unit D2 further includes a feeding drive unit D3. The feeding drive unit D3 is provided on the right side plate 90.

The feeding drive unit D3 includes the sheet feeding motor M2. The feeding drive unit D3 may include a gear (not illustrated) configured to transmit the driving force of the sheet feeding motor M2 to the inner plate 33, and/or a feeding drive train (feeding gear train) configured to transmit the driving force of the sheet feeding motor M2 to the feed roller 32.

FIG. 15 illustrates the printer 1 seen in the vertical direction V, more specifically, the printer 1 seen from the top-face side. In FIG. 15, the feeding drive unit D3 is hatched with oblique lines, and the imaging drive unit D1 is hatched with dots.

As described above, the power source unit EU is located above the imaging drive unit D1.

As illustrated in FIG. 15, as viewed in the vertical direction V, the power source unit EU and the imaging drive unit D1 at least partially overlap each other. In Example 1, as described above, the electric element 88b mounted on the wiring board 88a of the power source board 88 is located between the wiring board 88a and the right side plate 90 in the second direction. As illustrated in FIG. 15, as viewed in the vertical direction V, the wiring board 88a, the electric element 88b, and the power-source-board stay 99 overlap the imaging drive unit D1.

That is, as illustrated in FIG. 14, with respect to the first direction, the location (position) of the power source unit EU (the area (range) where the power source unit EU is disposed) and the location (position) of the imaging drive unit D1 (the area (range) where the imaging drive unit D1 is disposed) at least partially overlap each other. In other words, at least part of the power source unit EU is located directly above the imaging drive unit D1.

As illustrated in FIG. 14, with respect to the second direction, the location (position) of the feeding drive unit D3 and the location (position) of the imaging drive unit D1 at least partially overlap each other.

As illustrated in FIG. 14, with respect to the vertical direction V, the location (position) of the feeding drive unit D3 and the location (position) of the imaging drive unit D1 at least partially overlap each other.

As viewed from the top-face side, the fixing drive unit D2 and the power-source-board stay 99 are arranged in such a manner as not to overlap the discharge tray 1f. Thus, the power source board 88 can be placed in such a manner as to overlap the discharge tray (discharge tray) 1f in the second direction. Such an arrangement reduces the height of the printer 1 in the vertical direction V.

As illustrated in FIG. 14, in the vertical direction V, at least part of the fixing drive unit D2 is located higher than the imaging drive unit D1. In Example 1, at least part of the fixing drive unit D2 is located directly above the imaging drive unit D1. That is, as viewed in the vertical direction V, the fixing drive unit D2 at least partially overlaps the imaging drive unit D1.

With respect to the second direction, the location (position) of the imaging drive unit D1 (the area (range) where the imaging drive unit D1 is disposed) at least partially overlaps the location (position) of the fixing drive unit D2 (the area (range) where the fixing drive unit D2 is disposed). Thus, the size of the printer 1 in the second direction is reduced.

With respect to the first direction, the location (position) of the imaging drive unit D1 (the area (range) where the imaging drive unit D1 is disposed) at least partially overlaps the location (position) of the fixing drive unit D2 (the area (range) where the fixing drive unit D2 is disposed). Specifically, as illustrated in FIG. 15, the imaging drive unit D1 and the fixing drive unit D2 overlap each other in a range E1 with respect to the first direction.

Extending the fixing drive unit D2 rearward provides a satisfactory space for placing components inside the fixing drive unit D2. Instead, extending the fixing drive unit D2 rearward reduces the space for placing the power source unit EU. Nevertheless, as described above, the power source unit EU is located above the imaging drive unit D1. That is, the space above the imaging drive unit D1 is efficiently utilized for placing the power source unit EU. In the vertical direction V, the first board end 88a1 is shorter than the second board end 88a2.

Therefore, the length of the power-source-board stay 99 can be made shorter at an end portion thereof closer in the first direction to the first end portion 1b1 than at an end portion thereof closer in the first direction to the second end portion 1b2. Thus, the space produced by inclining the imaging drive train 74 is further efficiently utilized for placing the power source unit EU.

In Example 1, the imaging drive unit D1 and the feeding drive unit D3 are separate units. Alternatively, the imaging drive unit D1 and the feeding drive unit D3 may be integrated into a single unit, and the integrated unit may be placed on the bottom-face side in the vertical direction V relative to the fixing drive unit D2 and the power-source-board stay 99.

According to Example 1, the space, where the power source unit EU is disposed, is reduced.

### Advantageous Effects

The printer 1 according to the present embodiment includes the door 20 at the first end portion 1b1. Therefore, the tray unit 50, the transfer unit 40, the stacking tray 31, the fixing device 70, the conveyance path 1c, and the duplex conveyance path 20a are accessible at the first end portion 1b1. As described above, the inlet 82a is located closer to the second end portion 1b2 than to the first end portion 1b1 in the first direction. Therefore, the plug-equipped power cable inserted into the inlet 82a has no chance of hindering operations to be performed on the foregoing elements.

Since the door 20 is provided at the first end portion 1b1 while the inlet 82a is provided at the second end portion 1b2, the door 20 that is in the closed position and the inlet 82a are arranged in such a manner as to overlap each other as viewed in the first direction as illustrated in FIG. 13.

In the first direction, at least a part of the power source board 88 is located closer to the second end portion 1b2 than the fixing device 70 and closer to the first end portion 1b1 than the inlet 82a. Therefore, power is supplied through a short path from the inlet 82a through the power source board 88 to the fixing device 70.

In the first direction, the connector 82c is located closer to the first end portion 1b1 than the inlet 82a. Such an arrangement reduces the distance between the connector 82c and the supply connector 73 and accordingly reduces the length of the cable C5. That is, the cost related to the cable C5 is reduced.

In Example 1, the power source board 88 and the imaging drive unit D1 are provided on the right side plate 90. The power source board 88 includes the electric element 88b, such as a transformer, which is a tall element. On the other hand, the imaging drive unit D1 includes the motor M1. With respect to the second direction, the location (position) of the motor M1 (the area (range) where the motor M1 is disposed) and the location (position) of the electric element 88b (the area (range) where the electric element 88b is disposed) overlap each other. Thus, the space for placing the motor M1 and the electric element 88b is reduced.

Either of the control board 81 and the connection board 83 is regarded as an exemplary first electric board provided on either of the upper stay 93 and the first rear stay 92. If one of the control board 81 and the connection board 83 is defined as a first electric board, the other of the control board 81 and the connection board 83 is defined as an exemplary second electric board that is electrically connected to the first electric board.

The printer 1 according to the present embodiment includes the door 20 at the first end portion 1b1. Therefore, the tray unit 50, the transfer unit 40, the stacking tray 31, the fixing device 70, the conveyance path 1c, and the duplex conveyance path 20a are accessible at the first end portion 1bL. In other words, the printer 1 does not need to have on the rear-face side thereof an opening that allows access to the inside of the printer 1 and a door that covers the opening. Therefore, a satisfactory space for placing the electric board is provided on the rear-face side of the printer 1, and the space is utilized for placing the electric board.

The control board 81, the power source board 88, and the connection board 83 are connected to each other with connecting cables such as cables or flexible flat cables. The shorter the distance between the boards, the shorter the connecting cables and the greater the cost reduction. Furthermore, the shorter the connecting cables, the smaller the space for laying the connecting cables.

In the printer 1 according to Example 1, the control board 81 is located on the top-face side of the printer 1, the power source board 88 is located on the right-face side, and the connection board 83 is located on the rear-face side. More specifically, the control board 81 is provided on the upper stay 93, the power source board 88 is provided on the right side plate 90, and the connection board 83 is provided on the first rear stay 92. Thus, the control board 81, the power source board 88, and the connection board 83 are placed close to each other. Furthermore, since the control board 81, the power source board 88, and the connection board 83 are not concentratedly located on a single side of the printer 1 but are located on different sides, spaces on the respective sides are utilized.

In Example 1, the power source board 88 is located closer in the vertical direction V to the upper end of the printer 1 than to the lower end of the printer 1. Such an arrangement reduces the lengths of the cable C8 and the cable FFC3 that connect the control board 81 and the power source board 88 to each other. The control board 81 may be located closer in the second direction to the right side plate 90 than to the left side plate 91.

In the first direction, the control board 81 is located closer to the second end portion 1b2 than to the first end portion 1b1. Such an arrangement reduces the lengths of the cable C1 and the cable FFC1 that connect the control board 81 and the connection board 83 to each other.

In Example 1, a larger space is provided for the control board 81 than for the connection board 83.

The power source board 88, the inlet 82a, the supply connector 73, and the receiving connector 72 that are provided on the right side plate 90 in Example 1 may alternatively be provided on the left side plate 91.

### Example 2

Example 2 will now be described. In Example 2, elements having the same configurations as the elements described in Example 1 are denoted by the same reference signs, and detailed description of such elements is omitted in principle.

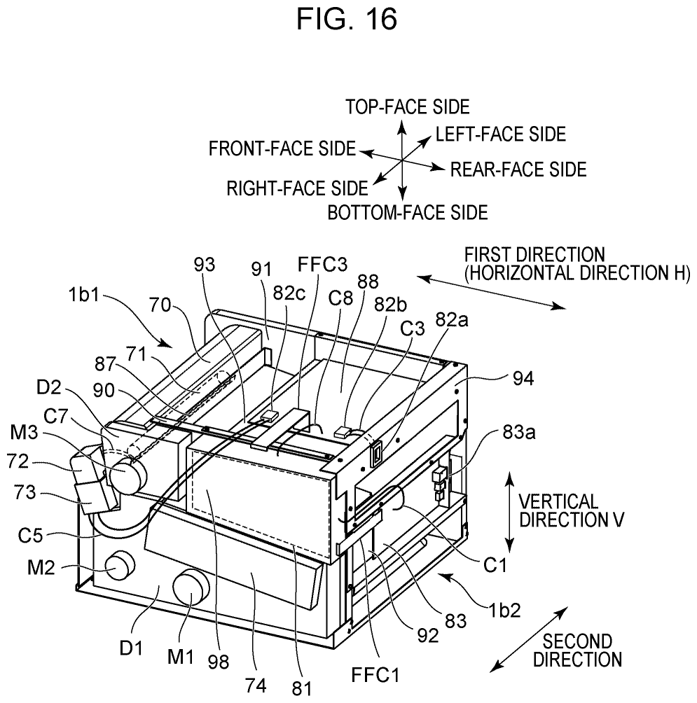

FIG. 16 illustrates the positions of electric components included in a printer 1 according to Example 2.

The printer 1 according to Example 2 is different from the printer 1 according to Example 1 in that the power source board 88 is provided on the upper stay 93 while the control board 81 is provided on the right side plate 90.

The right side plate 90 is provided with the control board 81 and a control-board stay 98, which serves as a casing that houses the control board 81. The control board 81 is supported by the control-board stay 98 and is fixed to the right side plate 90 with the aid of the control-board stay 98.

In Example 2, the inlet 82a is supported by the second rear stay 94. In the first direction, the inlet 82a is located closer to the second end portion 1b2 than to the first end portion 1b1. As viewed in the first direction, the inlet 82a overlaps the door 20 that is in the closed position. The inlet 82a is located higher in the vertical direction V than the rotation axis 20c of the door 20.

In Example 2, the inlet 82a is open in the first direction, more specifically, in a direction from the first end portion 1b1 toward the second end portion 1b2. The inlet 82a is located closer to the top of the apparatus body 1A than to the bottom of the apparatus body 1A. That is, the apparatus body 1A has an upper end and a lower end with respect to the vertical direction V, and the inlet 82a is located closer in the vertical direction V to the upper end than to the lower end.

### Advantageous Effects

In the printer 1 according to Example 2 as well, the plug-equipped power cable inserted into the inlet 82a has no chance of hindering operations to be performed on relevant elements included in the printer 1. Furthermore, since the door 20 is provided at the first end portion 1b1 while the inlet 82a is provided at the second end portion 1b2, the door 20 that is in the closed position and the inlet 82a are arranged in such a manner as to overlap each other as viewed in the first direction.

In the first direction, at least a part of the power source board 88 is located closer to the second end portion 1b2 than the fixing device 70 and closer to the first end portion 1b1 than the inlet 82a. Therefore, power is supplied through a short path from the inlet 82a through the power source board 88 to the fixing device 70.

In the first direction, the connector 82c is located closer to the first end portion 1b1 than the inlet 82a. Such an arrangement reduces the distance between the connector 82c and the supply connector 73 and accordingly reduces the length of the cable C5. That is, the cost related to the cable C5 is reduced.

### Example 3

Example 3 will now be described. In Example 3, elements having the same configurations as the elements described in either of Examples 1 and 2 are denoted by the same reference signs, and detailed description of such elements is omitted in principle.

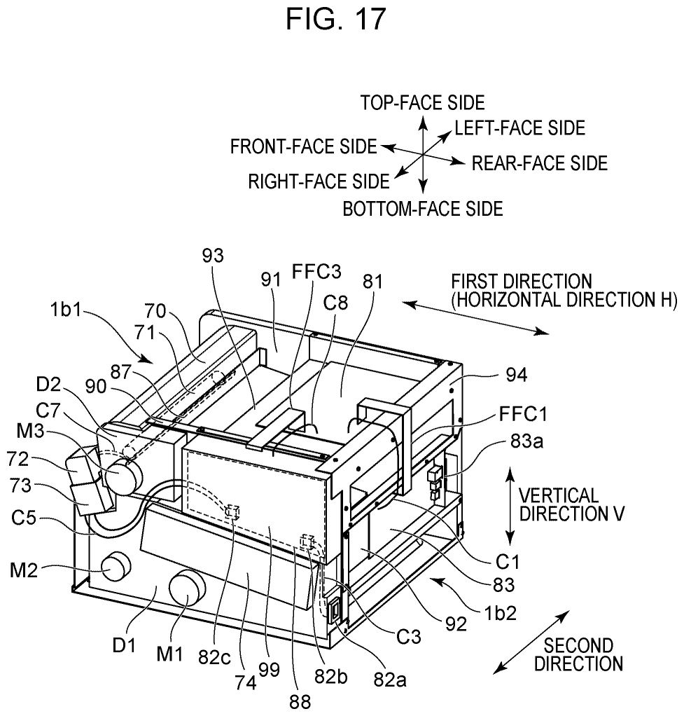

FIG. 17 illustrates the positions of electric components included in a printer 1 according to Example 3. The printer 1 according to Example 3 is different from the printer 1 according to Example 1 in that the inlet 82a is located closer in the vertical direction V to the bottom of the apparatus body 1A than to the top of the apparatus body 1A.

In Example 3 as well, the inlet 82a is located closer in the first direction to the second end portion 1b2 than to the first end portion 1b1. As viewed in the first direction, the inlet 82a overlaps the door 20 that is in the closed position. The inlet 82a is located higher in the vertical direction V than the rotation axis 20c of the door 20.

In Example 3, the inlet 82a is open in the first direction, more specifically, in a direction from the first end portion 1b1 toward the second end portion 1b2.

### Advantageous Effects

In the printer 1 according to Example 3 as well, the plug-equipped power cable inserted into the inlet 82a has no chance of hindering operations to be performed on relevant elements included in the printer 1. Furthermore, since the door 20 is provided at the first end portion 1b1 while the inlet 82a is provided at the second end portion 1b2, the door 20 that is in the closed position and the inlet 82a are arranged in such a manner as to overlap each other as viewed in the first direction.

In the first direction, at least a part of the power source board 88 is located closer to the second end portion 1b2 than the fixing device 70 and closer to the first end portion 1b1 than the inlet 82a. Therefore, power is supplied through a short path from the inlet 82a through the power source board 88 to the fixing device 70.

In the first direction, the connector 82c is located closer to the first end portion 1b1 than the inlet 82a. Such an arrangement reduces the distance between the connector 82c and the supply connector 73 and accordingly reduces the length of the cable C5. That is, the cost related to the cable C5 is reduced.

### Example 4

Example 4 will now be described. In Example 4, elements having the same configurations as the elements described in any of Examples 1 to 3 are denoted by the same reference signs, and detailed description of such elements is omitted in principle.

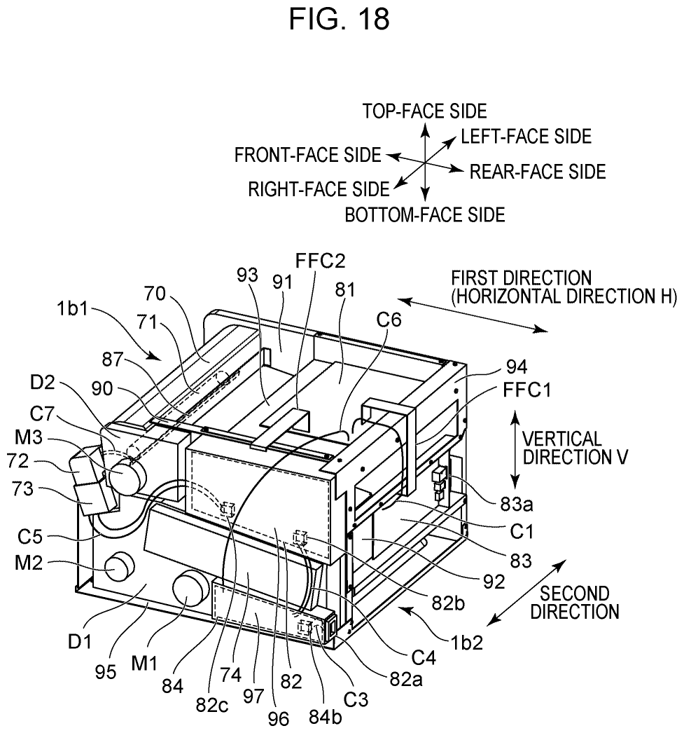

FIG. 18 illustrates the positions of electric components included in a printer 1 according to Example 4. The printer 1 according to Example 4 is different from the printer 1 according to Example 1 in that a fixing-power-source board 82 and an alternating current to direct current (AC-DC) power-source board 84 each have a similar function to the power source board 88 of the printer 1 according to Example 1. The printer 1 according to Example 4 is also different from the printer 1 according to Example 1 in that the inlet 82a is located closer in the vertical direction V to the bottom of the apparatus body 1A than to the top of the apparatus body 1A.

The right side plate 90 is provided with the AC-DC power-source board 84 and an AC-DC power-source stay 97, which serves as a casing that houses the AC-DC power-source board 84. The AC-DC power-source board 84 is supported by the AC-DC power-source stay 97 and is fixed to the right side plate 90 with the aid of the AC-DC power-source stay 97.

The right side plate 90 is provided with the fixing-power-source board 82 and a fixing-power-source stay 96, which serves as a casing that houses the fixing-power-source board 82. The fixing-power-source board 82 is supported by the fixing-power-source stay 96 and is fixed to the right side plate 90 with the aid of the fixing-power-source stay 96.

In Example 4, the inlet 82a is supported by the AC-DC power-source stay 97. In the first direction, the inlet 82a is located closer to the second end portion 1b2 than to the first end portion 1b1. As viewed in the first direction, the inlet 82a overlaps the door 20 that is in the closed position. The inlet 82a is located higher in the vertical direction V than the rotation axis 20c of the door 20.

The alternating-current voltage generated by the commercial power source is supplied through the cable C3 to a connector 84b, which is provided on the AC-DC power-source board 84. The AC-DC power-source board 84 includes an AC-DC converter (not illustrated) and is configured to convert commercial-power-source voltages into direct-current voltages of 24 V, 3.3 V, and so forth and to supply the direct-current voltages to the connection board 83, the control board 81, the imaging motor M1, the sheet feeding motor M2, and the fixing motor M3. In Example 4, the direct-current voltages of 24 V and 3.3 V are supplied to the control board 81 through a cable C6.

The cable C6 transmits a signal for controlling the operation of the AC-DC power-source board 84. The signal for controlling the operation of the AC-DC power-source board 84 includes a signal for changing the operation mode of the AC-DC converter when the printer 1 goes into a power-saving mode.

The alternating-current voltage supplied from the commercial power source to the AC-DC power-source board 84 is supplied to the connector 82b of the fixing-power-source board 82 through a cable C4. The alternating-current voltage generated by the commercial power source may be supplied as is to the fixing-power-source board 82 or may be supplied through a current fuse and/or a noise filter (not illustrated).

The fixing-power-source board 82 may carry a switching element such as a triac, a drive circuit, a circuit configured to detect the period and/or phase of the commercial power source, and so forth. The fixing-power-source board 82 is configured to control the triac to be turned on and off in such a manner as to exert a function of converting an alternating-current voltage into a desired voltage and supplying the converted voltage to the fixing device 70.

The fixing-power-source board 82 and the control board 81 are connected to each other with a cable FFC2. The cable FFC2 is a flexible flat cable. The cable FFC2 transmits a heater control signal generated by the control board 81 on the basis of a signal for detecting the phase of the commercial power source and the phase of the commercial power source.

On the basis of the heater control signal, the fixing-power-source board 82 controls the above-described triac to be turned on and off to supply electrical power to the heater 87 such that the heater 87 comes to have a desired temperature corresponding to the characteristic of the sheet S and/or the printing speed.

### Advantageous Effects

In the printer 1 according to Example 4 as well, the plug-equipped power cable inserted into the inlet 82a has no chance of hindering operations to be performed on relevant elements included in the printer 1. Furthermore, since the door 20 is provided at the first end portion 1b1 while the inlet 82a is provided at the second end portion 1b2, the door 20 that is in the closed position and the inlet 82a are arranged in such a manner as to overlap each other as viewed in the first direction.

In the first direction, at least part of the AC-DC power-source board 84 and at least part of the fixing-power-source board 82 are located closer to the second end portion 1b2 than the fixing device 70 and closer to the first end portion 1b1 than the inlet 82a. Therefore, power is supplied through a short path from the inlet 82a through the AC-DC power-source board 84 and the fixing-power-source board 82 to the fixing device 70.

### Example 5

Example 5 will now be described. In Example 5, elements having the same configurations as the elements described in any of Examples 1 to 4 are denoted by the same reference signs, and detailed description of such elements is omitted in principle.

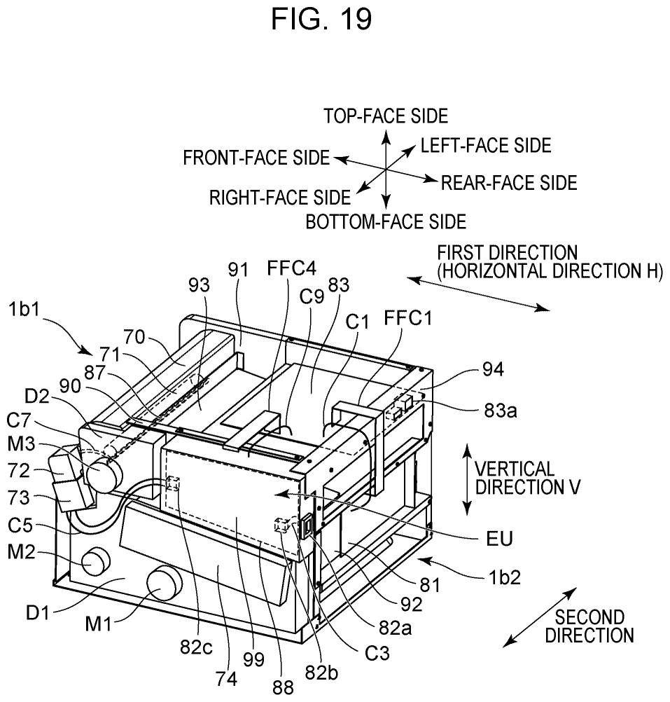

FIG. 19 illustrates the positions of electric components included in a printer 1 according to Example 5.

The printer 1 according to Example 5 is different from the printer 1 according to Example 1 in that the connection board 83 is provided on the upper stay 93 while the control board 81 is provided on the first rear stay 92. In Example 5, the connection board 83 is an exemplary upper board, and the control board 81 is an exemplary rear board.

In Example 5, the connector 83a of the connection board 83 is open toward the rear face of the printer 1. In Example 5, the connection board 83 and the power source board 88 are connected to each other with a cable C9 and a cable (flexible flat cable) FFC4, and the connection board 83 and the control board 81 are connected to each other with the cable C1 and the cable (flexible flat cable) FFC1.

The cable C9 is intended to supply electrical power that is used for activating elements included in the connection board 83 and in the control board 81. A signal for controlling the power source board 88 that is outputted from the control board 81 is transmitted to the power source board 88 through the cable FFC1 and the cable FFC4.

### Advantageous Effects

In Example 5 as well, either of the control board 81 and the connection board 83 is regarded as an exemplary electric board provided on either of the upper stay 93 and the first rear stay 92. If one of the control board 81 and the connection board 83 is defined as a first electric board, the other of the control board 81 and the connection board 83 is defined as an exemplary second electric board that is electrically connected to the first electric board.

In Example 5 as well, a satisfactory space for placing the electric board is provided on the rear-face side of the printer 1, and the space is utilized for placing the electric board.

In the printer 1 according to Example 5, the control board 81 is located on the rear-face side of the printer 1, the power source board 88 is located on the right-face side, and the connection board 83 is located on the top-face side. More specifically, the control board 81 is provided on the first rear stay 92, the power source board 88 is provided on the right side plate 90, and the connection board 83 is provided on the upper stay 93. Thus, the control board 81, the power source board 88, and the connection board 83 are placed close to each other. Furthermore, since the control board 81, the power source board 88, and the connection board 83 are not concentratedly located on a single side of the printer 1 but are located on different sides, spaces on the respective sides are utilized.

In Example 5, the power source board 88 is located closer in the vertical direction V to the upper end of the printer 1 than to the lower end of the printer 1. Such an arrangement reduces the lengths of the cable C9 and the cable FFC4 that connect the connection board 83 and the power source board 88 to each other. The connection board 83 may be placed closer in the second direction to the right side plate 90 than to the left side plate 91.

In the first direction, the connection board 83 is located closer to the second end portion 1b2 than to the first end portion 1b1. Such an arrangement reduces the lengths of the cable C1 and the cable FFC1 that connect the control board 81 and the connection board 83 to each other.

In Example 5, a larger space is provided for the connection board 83 than for the control board 81.

### Example 6

Example 6 will now be described. In Example 6, elements having the same configurations as the elements described in any of Examples 1 to 5 are denoted by the same reference signs, and detailed description of such elements is omitted in principle.

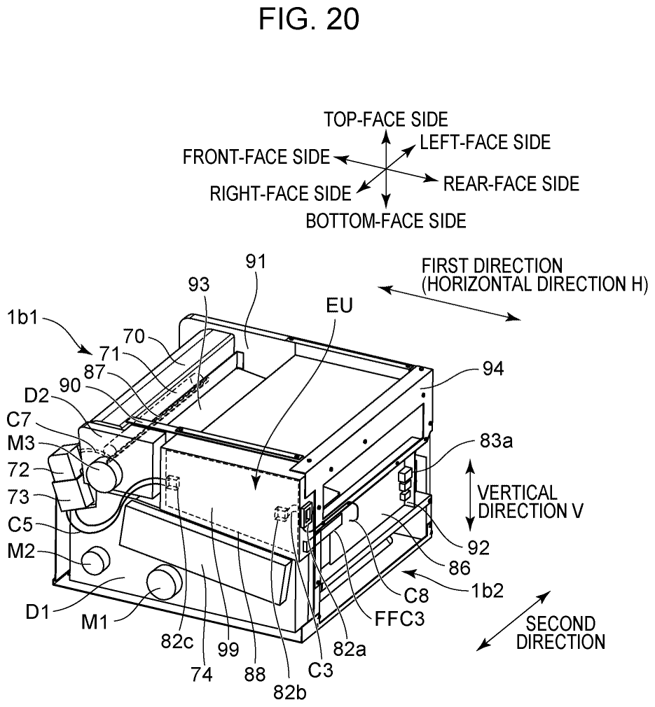

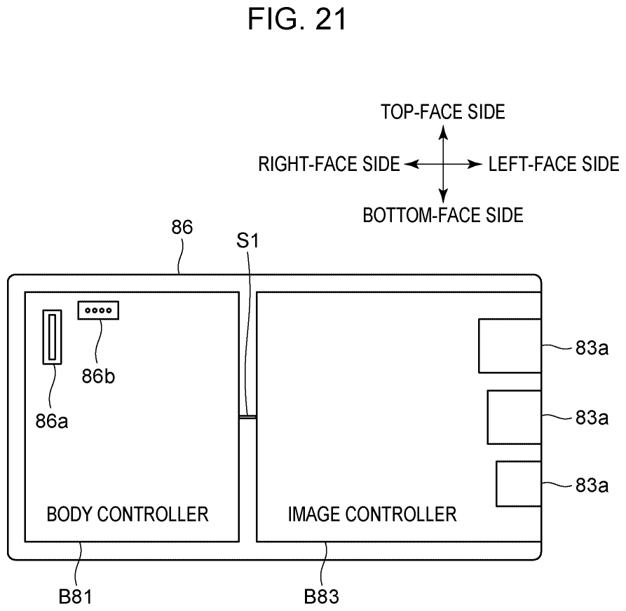

FIG. 20 illustrates the positions of electric components included in a printer 1 according to Example 6. FIG. 21 illustrates a control board 86 according to Example 6.

The printer 1 according to Example 6 is obtained by replacing the control board 81 and the connection board 83 according to Example 1 with the control board 86, which has both of the functions of the control board 81 and the connection board 83.

The control board 86 will now be described with reference to FIG. 21. The control board 86 includes an image controller B83, a body controller B81, and an image signal line S1, which connects the image controller B83 and the body controller B81 to each other.

The image controller B83 includes a plurality of connectors 83a, which are connected to the external instrument 400. The plurality of connectors 83a are each the same as the connector 83a according to Example 1.

The image controller B83 includes a CPU and a drive circuit for the CPU. The image controller B83 is configured to generate an image signal on the basis of a printing instruction received at any of the connectors 83a, and to transmit the image signal to the body controller B81 through the image signal line S1.

The body controller B81 is configured to execute the formation of an image on a sheet S on the basis of the image signal. The body controller B81 includes a CPU, a drive circuit for the CPU, and a circuit configured to generate high voltages and apply the high voltages to the cartridges P and to the transfer unit 40. The CPU of the body controller B81 is responsible for the activation of the motors (M1, M2, and M3), the supply of power to the heater 87, the control of the operation mode of the AC-DC converter, and so forth.

The body controller B81 includes a connector 86a, which is intended to receive the cable FFC3. The body controller B81 further includes a connector 86b, which is intended to receive the cable C8.

In Example 6, the connector 86a and the connector 86b are located closer in the second direction to the right side plate 90 than to the left side plate 91. Such an arrangement reduces the lengths of the cable FFC3 and the cable C8.

In Example 6, in the second direction, the image controller B83 is located closer to the left side plate 91 than the body controller B81, and the body controller B81 is located closer to the right side plate 90 than the image controller B83.

In the second direction, the connectors 83a are located closer to the left side plate 91 than to the right side plate 90, and the connector 86a and the connector 86b are located closer to the right side plate 90 than to the left side plate 91. Such an arrangement reduces the lengths of the cable FFC3 and the cable C8.

In Example 6, the control board 86 is located on the rear-face side of the printer 1. Alternatively, the control board 86 may be located on the top-face side. In that case, the control board 86 is provided on the upper stay 93. That is, the control board 86 may be provided on either of the upper stay 93 and the first rear stay 92.

### Advantageous Effects

In Example 6 as well, the control board 86 is regarded as an exemplary first electric board provided on either of the upper stay 93 and the first rear stay 92.

In the printer 1 according to Example 6, the control board 86 is located on the rear-face side or the top-face side of the printer 1, and the power source board 88 is located on the right-face side. More specifically, the control board 86 is provided on the first rear stay 92 or the upper stay 93, and the power source board 88 is provided on the right side plate 90. Thus, the control board 86 and the power source board 88 are placed closer to each other. Furthermore, since the control board 86 and the power source board 88 are not concentratedly located on a single side of the printer 1 but are located on different sides, spaces on the respective sides are utilized.

### Example 7

Example 7 will now be described. In Example 7, elements having the same configurations as the elements described in any of Examples 1 to 6 are denoted by the same reference signs, and detailed description of such elements is omitted in principle.

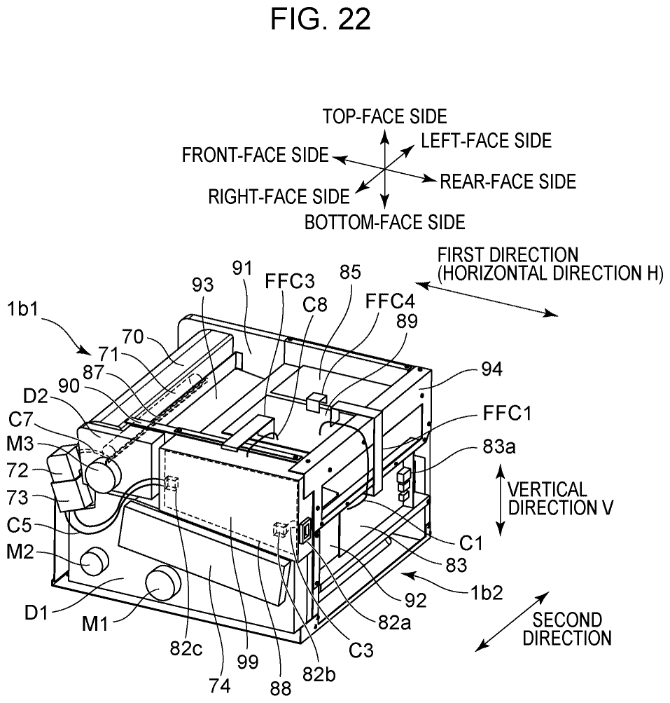

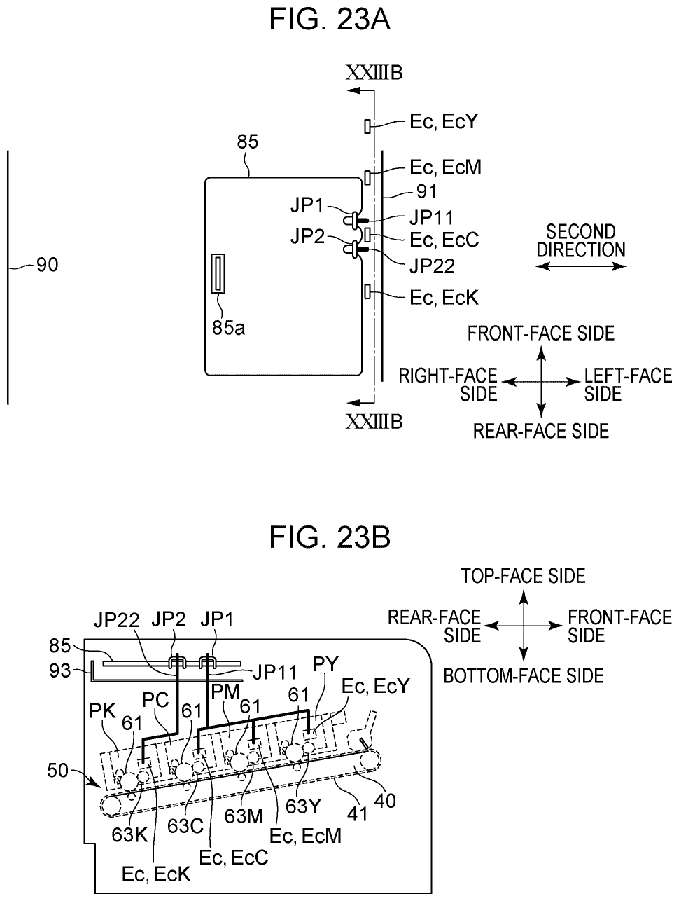

FIG. 22 illustrates the positions of electric components included in a printer 1 according to Example 7. FIGS. 23A and 23B illustrate how power is supplied to the tray unit 50.

The printer 1 according to Example 7 is obtained by replacing the control board 81 according to Example 1 with a control board 89 and a high-voltage board 85. The high-voltage board 85 includes a high-voltage-generating circuit, which is included in the control board 81 according to Example 1. The control board 89 has the same functions as the control board 81 according to Example 1 except the function of generating high voltages.

The control board 89 and the high-voltage board 85 are electrically connected to each other with a cable (flexible flat cable) FFC4. The control board 89 and the high-voltage board 85 are located adjacent to each other and are attached to the upper stay 93 in Example 7. Such an arrangement reduces the length of the cable FFC4.

The high-voltage board 85 is configured to perform a switching operation on a transformer or the like (not illustrated) in such a manner as to generate a desired voltage by increasing the voltage to be inputted to the transformer. In Example 7, the high-voltage board 85 is configured to generate direct-current voltages of 1000 V and 300 V, an alternating-current voltage of 120 V, and so forth.

In Example 7, the voltage to be inputted to the high-voltage board 85 is 24 V and is supplied from the control board 89 through the cable FFC4. A signal for switching the transformer is transmitted from the CPU of the control board 89 through the cable FFC4 to the high-voltage board 85.

The high voltages generated by the high-voltage board 85 are supplied to the tray unit 50. Referring now to FIGS. 23A and 23B, how such power is supplied from the high-voltage board 85 to the tray unit 50 will be described.

FIG. 23A illustrates the high-voltage board 85, the left side plate 91, and the right side plate 90 that are seen from the top-face side. A connector 85a, illustrated in FIG. 23A, is intended to receive the cable FFC4.

The high-voltage board 85 is provided at an end portion thereof with jumper wires (lead wires) JP1 and JP2. In Example 7, the jumper wires JP1 and JP2 are intended to supply high voltages as development biases to the developing rollers 63. The jumper wires JP1 and JP2 extend over respective slits provided in the high-voltage board 85.

The jumper wire JP1 is provided with a lead wire JP11. The jumper wire JP2 is provided with a lead wire JP22. The lead wire JP11 and the lead wire JP22 may have flexibility so as to be in pressure contact with the jumper wire JP1 and the jumper wire JP2, respectively. The jumper wire JP1 have the same potential as the lead wire JP11. The jumper wire JP2 has the same potential as the lead wire JP22.

As to be described below, the jumper wire JP1 is intended to supply a development bias to the yellow station, the magenta station, and the cyan station, whereas the jumper wire JP2 is intended to supply a development bias to the black station.

FIG. 23B illustrates a section taken along line XXIIIB-XXIIIB given in FIG. 23A, specifically, a section of the printer 1 that is seen from the left side.

As illustrated in FIG. 23B, the tray unit 50 has electric contacts Ec (EcY, EcM, EcC, and EcK). The electric contacts EcY, EcM, EcC, and EcK are electrically connected to the developing rollers 63Y, 63M, 63C, and 63K, respectively.

The voltages generated by the high-voltage board 85 are applied to the electric contacts EcY, EcM, EcC, and EcK. More specifically, the voltages generated by the high-voltage board 85 are applied through the jumper wire JP1 and the lead wire JP11 to the electric contacts EcY, EcM, and EcC, and through the jumper wire JP2 and the lead wire JP22 to the electric contact EcK.

In the second direction, the electric contacts EcY, EcM, EcC, and EcK are located closer to the left side plate 91 than to the right side plate 90. The high-voltage board 85 is located closer to the left side plate 91 than to the right side plate 90. Such an arrangement reduces the lengths of the lead wires JP11 and JP22, and accordingly reduces the cost related to the lead wires JP11 and JP22 and the space for laying the lead wires JP11 and JP22.

The configurations according to Examples 1 to 7 may be combined as appropriate and according to need.

According to the present disclosure, the known arts can further be developed.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-037323, filed Mar. 11, 2024, Japanese Patent Application No. 2024-037324, filed Mar. 11, 2024, and Japanese Patent Application No. 2024-037325, filed Mar. 11, 2024, which are each hereby incorporated by reference herein in their entirety.

What is claimed is:

1. An image forming apparatus configured to form an image on a recording material, the image forming apparatus comprising:
an apparatus body including a first end portion and a second end portion with respect to a first direction that is orthogonal to a vertical direction, the first end portion having an opening, the second end portion being located opposite the first end portion, the apparatus body including a first side wall located at one end of the apparatus body in a second direction that is orthogonal to the vertical direction and to the first direction;
a drawable unit movable relative to the first side wall in a direction intersecting the second direction, the drawable unit being movable between an inside position that is inside the apparatus body and an outside position that is outside the apparatus body through the opening;
a fixing device configured to heat the recording material and located closer to the first end portion than to the second end portion in the first direction;
a power source board configured to supply electrical power to the fixing device; and
an inlet electrically connected to the power source board and located closer to the second end portion than to the first end portion in the first direction,
wherein, in the first direction, at least part of the power source board is located closer to the second end portion than the fixing device is to the second end portion, and closer to the first end portion than the inlet is to the first end portion.

2. The image forming apparatus according to claim 1,
wherein the power source board is provided on the first side wall.

3. The image forming apparatus according to claim 1, further comprising:
a connecting member configured to electrically connect the power source board and the fixing device to each other,
wherein the power source board includes a connector to which the connecting member is connected, and
wherein, in the first direction, the connector is located closer to the fixing device than the inlet is to the fixing device.

4. The image forming apparatus according to claim 1,
wherein the power source board has a function of converting an alternating-current voltage received via the inlet into a direct-current voltage.

5. The image forming apparatus according to claim 4, further comprising:
a drive source configured to operate with a supply of the direct-current voltage,
wherein the drawable unit includes a rotary body configured to rotate with a driving force received from the drive source.

6. The image forming apparatus according to claim 1,
wherein the inlet is open in a direction from the first end portion toward the second end portion.

7. The image forming apparatus according to claim 1,
wherein the apparatus body includes a second side wall that is located opposite the first side wall in the second direction,
wherein the fixing device includes a receiving connector configured to receive electrical power from the power source board, and
wherein, in the second direction, the receiving connector is located closer to the first side wall than to the second side wall.

8. The image forming apparatus according to claim 7, further comprising:
a supply connector electrically connected to the power source board and connectable to the receiving connector,
wherein, in the first direction, the supply connector is located closer to the first end portion than to the second end portion.

9. The image forming apparatus according to claim 1,
wherein the power source board has a first power-source end and a second power-source end with respect to the first direction, the second power-source end being located opposite the first power-source end, and
wherein, in the first direction, the first power-source end is located closer to the first end portion than to the second end portion, and the second power-source end is located closer to the second end portion than to the first end portion.

10. The image forming apparatus according to claim 1, further comprising:
an opening-and-closing member movable between a closed position where the opening-and-closing member covers the opening and an open position where the opening is exposed,
wherein, with respect to the second direction, a range where the opening-and-closing member is disposed and a range where the inlet is disposed overlap each other.

11. The image forming apparatus according to claim 1,
wherein the apparatus body has an upper end and a lower end with respect to the vertical direction, and
wherein, in the vertical direction, the inlet is located closer to the upper end than to the lower end.

12. The image forming apparatus according to claim 1,
wherein the drawable unit includes a tray and a cartridge, the cartridge being detachably attached to the tray.

13. An image forming apparatus configured to form an image on a recording material, the image forming apparatus comprising:
an apparatus body including a first end portion and a second end portion with respect to a first direction that is orthogonal to a vertical direction, the first end portion having an opening, the second end portion being located opposite the first end portion, the apparatus body including a first side wall; a second side wall; a rear wall; and an upper wall, the first side wall being located at one end of the apparatus body in a second direction that is orthogonal to the vertical direction and to the first direction, the second side wall being located at the other end of the apparatus body in the second direction, the rear wall being located at the second end portion, at least part of the rear wall being located between the first side wall and the second side wall in the second direction, at least part of the upper wall being located between the first side wall and the second side wall in the second direction;
a drawable unit movable relative to the first side wall in a direction intersecting the second direction, the drawable unit being movable between an inside position that is inside the apparatus body and an outside position that is outside the apparatus body through the opening, at least part of the drawable unit that is in the inside position being located below the upper wall;
a fixing device configured to heat the recording material and located closer to the first end portion than to the second end portion in the first direction;
a power source board provided on the first side wall; and
a first electric board provided on the rear wall or the upper wall.

14. The image forming apparatus according to claim 13, further comprising:
a second electric board electrically connected to the first electric board,
wherein one of the first electric board and the second electric board is an upper board provided on the upper wall, and the other of the first electric board and the second electric board is a rear board provided on the rear wall.

15. The image forming apparatus according to claim 14,
wherein one of the upper board and the rear board includes a connector that is connectable to an external device.

16. The image forming apparatus according to claim 15, further comprising:
a drive source,
wherein the drawable unit includes a rotary body configured to be driven by the drive source, and
wherein the other of the upper board and the rear board is a control board configured to receive a signal outputted from the one of the upper board and the rear board and to control at least one of the drive source and the fixing device.

17. The image forming apparatus according to claim 14,
wherein the upper board is located closer to the first side wall than to the second side wall in the second direction.

18. The image forming apparatus according to claim 13, further comprising:
a drive source,
wherein the drawable unit includes a rotary body configured to be driven by the drive source, and
wherein the first electric board includes a connector connectable to an external device and is configured to control at least one of the drive source and the fixing device.

19. The image forming apparatus according to claim 13, further comprising:
an electric contact provided on the drawable unit; and
a high-voltage board configured to generate a voltage to be applied to the electric contact,
wherein the electric contact is located closer to the second side wall than to the first side wall in the second direction, and
wherein the high-voltage board is located closer to the second side wall than to the first side wall in the second direction.

20. The image forming apparatus according to claim 19,
wherein the high-voltage board is provided on the upper wall.

21. The image forming apparatus according to claim 13,
wherein the power source board is configured to receive an alternating-current voltage supplied via an inlet.

22. The image forming apparatus according to claim 21,
wherein the power source board has a function of converting the alternating-current voltage into a direct-current voltage.

23. The image forming apparatus according to claim 13,
wherein the power source board is configured to supply electrical power to the fixing device.

24. The image forming apparatus according to claim 13,
wherein the drawable unit includes a tray and a cartridge, the cartridge being detachably attached to the tray.

25. An image forming apparatus configured to form an image on a recording material, the image forming apparatus comprising:
an apparatus body including a first end portion and a second end portion with respect to a first direction that is orthogonal to a vertical direction, the second end portion being located opposite the first end portion, the apparatus body including a first side wall located at one end of the apparatus body in a second direction that is orthogonal to the vertical direction and to the first direction;
an image forming unit configured to transfer an image to a recording material at a transfer portion, the image forming unit including a drawable unit movable between an inside position that is inside the apparatus body and an outside position that is outside the apparatus body, the drawable unit including a plurality of rotary bodies including a first rotary body and a second rotary body, the transfer portion being located closer to the first end portion than to the second end portion in the first direction;
a drive unit including a drive source and a drive train, the drive train being configured to transmit a driving force of the drive source to each of the first rotary body and the second rotary body, the drive unit being provided on the first side wall;
a fixing device configured to heat the recording material and located closer to the first end portion than to the second end portion in the first direction; and
a power source unit provided on the first side wall, the power source unit including a power source board and a casing that houses the power source board,
wherein when the drawable unit is in the inside position, the first rotary body is located closer to the first end portion than the second rotary body is to the first end portion in the first direction, and at least part of the first rotary body is located higher than the second rotary body in the vertical direction,
wherein the power source unit is located above the drive unit in the vertical direction, and
wherein as viewed in the vertical direction, the power source unit and the drive unit at least partially overlap each other.

26. The image forming apparatus according to claim 25,
wherein the drawable unit is movable in a direction intersecting the second direction.

27. The image forming apparatus according to claim 26,
wherein the drawable unit is movable between the inside position and the outside position through an opening provided at the first end portion.

28. The image forming apparatus according to claim 25,
wherein the image forming unit includes an intermediate transfer belt, and
wherein the first rotary body is a first photoconductor drum that is allowed to come into contact with the intermediate transfer belt, and the second rotary body is a second photoconductor drum that is allowed to come into contact with the intermediate transfer belt.

29. The image forming apparatus according to claim 28, further comprising:
a transfer roller configured to form the transfer portion between the intermediate transfer belt and the transfer roller,
wherein when the drawable unit is in the inside position, at least part of the second photoconductor drum is located below the transfer roller in the vertical direction.

30. The image forming apparatus according to claim 25, further comprising:
a discharge tray on which the recording material having an image formed is stackable,
wherein as viewed in the second direction, the discharge tray and the power source board overlap each other.

31. The image forming apparatus according to claim 25, further comprising:
a fixing roller included in the fixing device; and
a fixing drive unit configured to drive the fixing roller,
wherein at least part of the fixing drive unit is located above the drive unit in the vertical direction.

32. The image forming apparatus according to claim 25, further comprising:
a stacker on which the recording material is stackable;
a feeding roller configured to convey the recording material from the stacker; and
a feeding drive unit configured to drive the feeding roller,
wherein, with respect to the second direction, a position of the feeding drive unit and a position of the drive unit at least partially overlap each other.

33. The image forming apparatus according to claim 32,
wherein, with respect to the vertical direction, a position of the feeding drive unit and a position of the drive unit at least partially overlap each other.

34. The image forming apparatus according to claim 25,
wherein the power source board includes a first board end and a second board end with respect to the first direction, and
wherein the first board end is located closer to the first end portion than the second board end is to the first end portion in the first direction, and the first board end is shorter than the second board end with respect to the vertical direction.

35. The image forming apparatus according to claim 25,
wherein the power source board is configured to receive an alternating-current voltage supplied via an inlet.

36. The image forming apparatus according to claim 35,
wherein the power source board has a function of converting the alternating-current voltage into a direct-current voltage.

37. The image forming apparatus according to claim 25,
wherein the drawable unit includes a tray and a cartridge, the cartridge being detachably attached to the tray.

38. An image forming apparatus configured to form an image on a recording material, the image forming apparatus comprising:
an apparatus body including a first end portion and a second end portion with respect to a first direction that is orthogonal to a vertical direction, the first end portion having an opening, the second end portion being located opposite the first end portion, the apparatus body including a first side wall located at one end of the apparatus body in a second direction that is orthogonal to the vertical direction and to the first direction;
a drawable unit movable relative to the first side wall in a direction intersecting the second direction, the drawable unit including a rotary body, the drawable unit being movable between an inside position that is inside the apparatus body and an outside position that is outside the apparatus body through the opening;
a drive unit including a drive source and a drive train, the drive train being configured to transmit a driving force of the drive source to the rotary body, the drive unit being provided on the first side wall;
a fixing device configured to heat the recording material and located closer to the first end portion than to the second end portion in the first direction; and
a power source unit provided on the first side wall, the power source unit including a power source board and a casing that houses the power source board,
wherein defining a direction of travel of the drawable unit moving from the inside position to the outside position as a drawing direction, the drawable unit that is in the inside position is inclined such that a downstream portion of the drawable unit in the drawing direction is located higher than an upstream portion of the drawable unit,
wherein the power source unit is located above the drive unit in the vertical direction, and
wherein as viewed in the vertical direction, the power source unit and the drive unit at least partially overlap each other.
